(19) United States
(12) Patent Application Publication
(10) Pub. No.: US 2004/0148356 A1
(43) Pub. Date: Jul. 29, 2004

(54) System and method for private messaging

(76) Inventors: James William Bishop JR., Colorado Springs, CO (US); Richard Mo, Colorado Springs, CO (US); Ganesh Kumar Godavari, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/701,355

(22) Filed: Oct. 4, 2003

Related U.S. Application Data
(60) Provisional application No. 60/423,705, filed on Nov. 4, 2002.
(60) Provisional application No. 60/436,227, filed on Dec. 23, 2002.
(60) Provisional application No. 60/466,910, filed on May 1, 2003.
(60) Provisional application No. 60/477,736, filed on Jun. 11, 2003.

(51) Int. Cl. G06F 15/173; G06F 15/16

(52) U.S. Cl. 709/206; 709/238

(57) ABSTRACT

An electronic message system that includes a messaging infrastructure to transport an electronic message, where the message includes a message header, a first messaging agent and a second messaging agent in communication with the messaging infrastructure, and a message server to route the message from the first messaging agent to the second messaging agent, where the network server is in communication with the messaging infrastructure, and where the message header is encrypted when being transported by the messaging infrastructure. Also, a method of transporting an electronic message, that includes sending the message from a sender to a message server, where the message server verifies the sender is a sending agent that is registered with the message server, decrypting a message header in the message to ascertain the recipients to receive the message, verifying the recipients are recipient agents that are registered with the message server, and sending the message.

### RELATED INVENTIONS

The present application claims the benefit of U.S. Provisional patent application 60/423,705 filed on Nov. 4, 2002; U.S. Provisional patent application 60/436,227 filed on Dec. 23, 2002; U.S. Provisional patent application 60/466,910 filed on May 1, 2003; and U.S. Provisional patent application 60/477,736 filed on Jun. 11, 2003, each of which are incorporated herein in their entirety by reference.

### BACKGROUND OF THE INVENTION

1. Field of the Invention

This invention pertains in general to electronic messaging (e.g., email and similar communication media), and in particular to providing private messaging. It also pertains to use of the private messaging capability so enabled for the distribution and management of sensitive information, and in particular to controlling access and redistribution rights associated with such information. It further pertains to use of the private messaging capability so enabled to reduce the prevalence of unsolicited messages from commercial and disreputable senders, commonly referred to as “spam.” It also pertains to use of the private messaging capability so enabled for the management of personal information shared among multiple devices owned by different people, and in particular to keeping that information up to date automatically whenever it changes in the device of its owner. It further pertains to use of the private messaging capability so enabled for the management of schedule information distributed among multiple devices owned by different people, and in particular to coordinating appointments automatically on behalf of those people.

2. Relevant Background

Numerous computer software applications and dedicated hardware devices exist today which provide a personal electronic messaging function, generally known as email but also appearing in the form of instant messaging and short message service. These programs and devices facilitate composition, transmission, reception, presentation, and storage of messages, and work in conjunction with network servers to transport messages among users. Well-known examples include Microsoft Corporation's Outlook and Outlook Express, AOL-TimeWamer's Netscape Communicator, Pine, elm, and many more.

In general, email and its relatives are considered insecure, or non-private, services, because no effort is made to obscure the content of any message in the typical system. An observer stationed strategically in the network would be able to read any message that passes. However, a number of techniques exist whereby correspondents may use encryption to make the message content unreadable by anyone who does not possess the encryption parameters (algorithm and keys) applied to the particular message.

Conventional techniques for encrypting message content include attachment encryption and end-to-end message encryption using PGP. Attachment encryption may be carried out with applications that support Internet Standard secure email via compliance with the S/MIME protocol. Also, a sender can create content as a separate file, encode it using a standalone encryption program such as “crypt” or “WinZip” (even though WinZip is a compression and archiving program, its ability to password-protect a file is a form of encryption), and attach it to a message containing nothing else.

End-to-end message encryption with PGP (“Pretty Good Privacy”) may enhance popular messaging applications. PGP provides excellent end-to-end privacy by layering public-key digital signatures with fast single-use-key encryption in a manner that is reasonably well-integrated with the messaging applications.

Because existing techniques for providing private messaging operate on an end-to-end basis, encryption keys, such as the file password when using an encrypted attachment or the public keys when using PGP or S/MIME, are exchanged directly with each correspondent through some other medium. For example, file passwords might be exchanged vocally on a phone call, and PGP public keys might be traded via floppy diskette during a meeting. This feature can be considered both a boon, because it offers greater assurance of key validity and/or key privacy as appropriate, and a bane, because it requires significant effort on the user's part to manage key material for each correspondent.

Thus, there is a need for a system for sending and receiving private messages that is simpler to use than any of the present end-to-end options, and more pervasive than can be achieved with enterprise-constrained or web-based systems. Such a system would provide automatic distribution and management of key material for all users, regardless of affiliation. It would also allow a user to continue with her existing messaging address, thereby avoiding the potentially massive headache of sending correspondents a change of address notice.

Associated with the problem of private messaging is the problem of mutually assuring the authenticity of correspondents. Prior art systems support mutual authentication by providing cryptographically sound signature functions. This technique assures that a message can be sent and received only by holders of specific key material. However, it falls upon the users themselves to exchange and handle key material in such a way that certificates are associated correctly with their owners. It does no good to encrypt a message for a particular recipient if the sender is not certain that the key material in hand corresponds to the intended recipient. Likewise, a sender's identity must be verifiable by each recipient of a message. This can be a significant burden, but is one that must be borne to use prior-art systems. Thus, there also is a need for a system for exchanging and handling key material for use in a private messaging system that relieves users of the burden while assuring them of each other's authenticity.

Another attribute of private messaging relates to the routing of messages from a sender to one or more recipients. Because present end-to-end techniques rely upon standard message routing, in which the addresses of at least the recipients and generally also the sender must be readable by message routing computers (such as mail servers), this information must be left unencrypted. That means privacy of correspondents is not achieved, which may or may not be significant for certain users and certain messages. It is desirable to conceal recipients' addresses when sending a message, and to conceal the sender's and other recipients' addresses when receiving a message. To conceal both sender and receiver at both ends is practical only in a closed network that does not exchange messages with non-participating users; this is not a desirable attribute in a simplified system suitable for all users.

What is needed, then, is a technique for sending and receiving private messages which is simpler to use than any of the present end-to-end options; that is, a technique which does not require the user to acquire and manage cryptographic key material for each correspondent. What is further needed is a technique for sending private messages which makes recipients' addresses private, and for receiving private messages which makes senders' and other recipients' addresses private. Such a system will preferably allow users to continue exchanging non-private messages with others as well, and will integrate the private messaging experience and tools with the user's existing experience and tools for non-private messaging.

A further aspect of private messaging relates to the ability to retract, or recall, a message after it has been sent. For example, people often inadvertently address messages inappropriately, sharing personal information intended for family and friends with business associates, or copying a bit of gossip to the person who is the subject of the gossip. Invariably the sender regrets this Freudian slip and wishes the message could be recalled prior to it being read by the unintended recipient. Some existing email systems, notably Microsoft Exchange and a few others that are generally intended for use in large enterprises, provide a feature that attempts to do this.

These systems, however, are all constrained to the local server's scope, and can only remove a message from the server that has not been read by any of its recipients who are also on that server. Once a message has been read or relayed, the recall will fail. Therefore, users generally learn that the recall feature is unreliable at best, and simply do not attempt to use it. Thus, there is a need for a pervasive messaging system in which the sender of any message can reliably retract it permanently, without regard to the scope of any enterprise or messaging service provider, so that its original recipients either no longer have a copy of it, or at least can no longer read it under any circumstances.

Yet another aspect of private messaging relates to the avoidance of messages containing unwanted solicitations, sometimes called unsolicited commercial email but commonly referred to as spam. Such messages are generally sent in large quantities to random recipients by less-than-reputable organizations or individuals, and often contain advertisements for products outside the experience of mainstream consumers. Often, the information in such messages is considered offensive by most people.

Many systems exist which attempt to prevent the flow of spam. The most common technique involves lexically scanning each message passing through a server or arriving in a user's mailbox, and discarding or setting aside those messages, which match certain patterns. One widely-used such system is the Brightmail message filtering service. Others include filtering capabilities built into popular message handling software such as sendmail, Microsoft Exchange, and Microsoft Outlook. Usually, the email address of the sender is forged in order to evade these filters, and spammers tend to change their message content frequently as well, again in an attempt to evade filters. Thus the filters can never be 100% effective.

Further, while lexical scanners and other filters can, to some degree, prevent users from receiving spam, they cannot prevent the messages from being sent in the first place. Therefore, the network traffic associated with spam is not avoided. Several techniques exist which attempt to prevent those who create spam from being able to send any messages at all. However, these tend to depend on vigilance by large numbers of network administrators, and can easily be circumvented by intentional non-conformers. As well, the practice of forging headers mentioned above contributes further to the difficulty in this problem. Because there is no shortage of such non-conformant service providers, the cost of spam to its senders is so low that they can generate enormous volumes of it and still recover the cost with only a few responses. Thus the cost of spam is actually borne more by those users who don't want it than by the spammers and their customers. Only by raising the cost or reducing the response rate can the spammer's business model be rendered unworkable.

Recently, proposals have been made that attempt to shift the cost of messaging to senders by having them perform costly tasks for each message. In one approach, cited in the April, 2003, issue of Technology Review, unknown senders are forced by the recipient to spend roughly 10 seconds computing the response to a challenge, thereby proving their legitimate desire to have the message accepted. In another, cited Mar. 20, 2003 by InternetWeek, messages from unknown senders are rejected unless they carry a code which must be purchased from a charitable organization. These proposals do-appear to shift costs to senders in a way that would destroy the spammer's business case. However, they also rely upon significant infrastructure changes within the messaging network in order to operate, and require senders to take steps that benefit recipients with no corresponding advantage to themselves.

What is needed, then, is a messaging system that can be overlaid upon the existing infrastructure without impact to it, and into which only legitimate message traffic can enter. Such a system would provide sufficient value to end users, both senders and recipients, that a reasonable fee can be charged for sending a reasonable number of messages. Multiple levels of service can be offered for heavy and light users, but the system would simply not offer a service level that permits a user to send the number of messages required by successful spammers. Recipients can thus be assured that any message arriving through such a system is legitimate. In conjunction with the authenticity of correspondents' addresses noted previously as a needed attribute, the spammers' primary tools are thus obviated: unlimited low-cost message traffic becomes unavailable, and forging headers becomes impossible. As more end users rely exclusively on such a system for their messaging needs, the probability of a spammer's message reaching any recipients gets low enough that it becomes no longer economically sensible to bother sending it.

Yet another aspect of message privacy relates to controlling what the message's recipients can do with the information in it. Existing messaging systems facilitate extracting message content to files, forwarding messages to other users, printing message content onto paper, and copying message text to other programs. However, in some situations the sender of a message may wish to prevent its recipients from extracting or propagating message content in this fashion.

Many systems have been created that provide such functionality, which is commonly called “Digital Rights Management,” or DRM. Known prior art DRM systems are specifically intended for use either by enterprises in controlling distribution of proprietary information, or by media content creators in tracking and billing consumption of their product. The latter include so-called “digital watermarking” techniques and “electronic books,” and are generally not integrated with messaging systems but instead apply to files no matter how they are distributed. Examples include products from Sealed Media and Adobe, among many others. In the enterprise space, the prevailing approach is to enforce distribution policies using a centralized server that examines all data it is hosting and applies encryption and file permissions as appropriate. One such system is the Alchemedia Mirage Server.

While that system does not integrate with the flow of messages, other systems using similar principles do. For example, the defunct company Interosa created an integrated DRM and email privacy system wherein a centralized server, in conjunction with a specialized client software application, enforced various information access policies on all messages flowing through it. Microsoft itself has recently announced such a system, integrated with its messaging and content products, and also using a server to control information access.

In each of these prior-art systems, their focus on the requirements of large corporations leads to an explosion of functionality and flexibility, along with a corresponding explosion of complexity and cost. Automatic enforcement of arbitrary security policies is a very large, very difficult problem. Further, its solution has little or no bearing on the needs of individual end users. No low-cost and simple-to-use DRM system exists that is suitable for deployment in small businesses such as those of independent consultants, professional practices, artists, and writers. Nor is there any solution intended for private individuals and personal use. Even some medium-size and large enterprises may have simpler needs than anticipated by existing DRM systems.

What is needed, then, is a very simple but highly effective system which allows end users to indicate that the content of a message must not be shared beyond its immediate audience, and have that indication enforced. Such a system must prevent the recipients of a restricted message from forwarding the message, from printing its contents, from selecting all or any part of its contents and copying them, and from exporting the contents to a separate file. So that the needed system may serve as broad a population as possible, it would also not rely upon availability of a centralized server at the instant of information access to enforce these redistribution constraints; nor would it require its users to abandon their accustomed messaging environment or address.

With such a private messaging capability in place, additional uses can be created. One such application involves the automatic secure sharing of personal information. Numerous computer software applications and dedicated hardware devices exist today which provide a personal information management (PIM) function. These programs and devices typically are designed to hold one or more of the following general types of personal information: its user's agenda (calendar and outstanding tasks), phone list or address book (contact information for each colleague, correspondent, acquaintance, etc.), and notes (miscellaneous important information). Some such programs and devices also include or cooperate with communication capabilities such as email.

Well-known examples of programs and devices which include PIM functionality include personal digital assistant (PDA) devices such as those produced by Palm Computing and its partners, and combination email/contact/calendar application programs such as Microsoft Outlook.

A significant portion of the information stored in one PIM device or program actually reflects the content of one or several others. Two classes of shared information can be defined here. First, a single user or organization may maintain a single data set in multiple devices used for different but related purposes. This occurs when, for example, an individual keeps an email address book on a personal computer, a phone number directory in a cellular phone, and a contact database in a PDA, all of which contain entries for the same people. Ensuring these lists are all current and reflecting the same information, particularly the phone number which is recorded in both the phone and the PDA, or the email address which is recorded in both the email address book and the PDA, constitutes the synchronization problem, which is well-known to those skilled in the art, and for which many solutions are available in the marketplace.

Second, multiple users, each with their own PIM program or device, may each record a specific item as one of several; while overall these users have different datasets, one or more entries containing the same information appear in more than one dataset. This occurs when, for example, one individual's contact details (name, address, phone number, etc.) appear in many others' address books, or when each participant in a meeting has a calendar entry reflecting the meeting's details (date, time, location, topic, etc.). Managing such shared personal information is generally solved within closed domains such as enterprise networks using so-called “groupware” systems, which typically store all information in a centralized server and require users to be “logged on” (connected to the network and server) to see their personal information.

Although so-called “offline” caching of the dataset is usually a feature of these systems, users create mismatches between the clients' and server's data when making changes in the “offline” state, and a great deal of system complexity is expended resolving such mismatches. Since often only information directly relevant to the closed domain is permitted to reside in its server, individual users prefer not to delegate their personal non-domain-relevant information to the domain, and the administrators of closed domains are usually reluctant to connect their systems with one another for information security reasons, the general case of managing both domain and non-domain personal information across PIM programs or devices used by multiple individuals in multiple domains has so far been considered an intractable problem. Only manual updates supported by personal interaction via direct contact and telecommunication have been able to keep such shared personal information up to date. Due to the effort required, many items of personal information fail to be updated and become stale over time. For example, when the frequency of routine interaction with a correspondent is lower than the frequency with which that correspondent's contact information changes, contact is lost.

What is needed, then, is a system whereby the personal information that is shared among multiple people, or that one person intentionally shares with several others, can be kept up to date automatically and with complete confidence in its validity as it changes, without regard to closed domains and without resorting to centralized data. It is thus a further aim of this invention to provide just such a system.

Yet another application benefits from a private messaging capability. When a number of correspondents desire to arrange a meeting with one another, it is often a tedious process to establish a date, time, and location at which all can be available. The usual approach is for one individual, the organizer, to contact everyone else by email or telephone and propose meeting parameters. The organizer must then await responses from each, determine whether they all agree or not to the proposal, and if not create a new proposal; this is repeated until a common set of parameters is found to which all participants agree. This can take as little as a few minutes, or as much as several days, depending on the correspondents' responsiveness and relative busy-ness.

As with shared personal information, this process can be simplified within an enterprise using groupware. In a typical implementation, a calendaring server holds every user's schedule, and presents to requestors scheduling a meeting a view of each users availability. The requestor can then pick an optimal date and time from the common clear times in each participant's schedule.

Unfortunately, for the same reasons as mentioned above, groupware ordinarily works only within a single enterprise domain, and so fails to serve in those situations where participants must be gathered from multiple domains. To be effective even within the domain, it requires all users to keep their schedules in the server, which again leads to a synchronization problem. It is also particularly difficult for users to justify committing information about their personal appointments to the enterprise calendar server, and to keep that information current, when it normally resides quite naturally in a PDA.

What is needed, then, is a system whereby the organizer of a meeting can directly query the availability of desired participants, automatically without awaiting responses from each correspondent individually, and establish a tentative appointment in each of those participants' schedules, without relying on a centralized calendar server. Such a system would securely share exactly and only the schedule information each user desires to be shared, directly from the PDA or computer in which the user's schedule is kept. It is thus a further aim of this invention to provide a system with these capabilities.

One of the aims of the present invention is to create a private messaging solution that is both simpler for its users than existing options, and which offers additional protection for the information in their messages, and which does not require users to abandon existing messaging services. Another aim of the present invention is to create a private messaging solution that is both simpler and more secure for its users than existing options, permits message senders to retract messages reliably, and permits originators of message content to restrict whether that content may be used by its recipients beyond reading it in the message.

Still another aim is to provide assurance of the correspondence between a user's messaging address and encryption keys, again in a fashion that is far simpler to use than is achieved in the prior art. In conjunction with this aim, the present invention further aims to eliminate the flow of spam directed at its users. Yet another aim is to provide these capabilities at a cost that is bearable to multitudes of end users, without requiring them to abandon their existing accustomed messaging environments.

### SUMMARY OF THE INVENTION

One embodiment of the invention includes an electronic message system comprising a messaging infrastructure to transport an electronic message, wherein the message includes a message header, a first messaging agent and a second messaging agent in communication with the messaging infrastructure, and a message server to route the message from the first messaging agent to the second messaging agent, wherein the network server is in communication with the messaging infrastructure, and wherein the message header is encrypted when being transported by the messaging infrastructure.

Another embodiment of the invention includes a method of transporting an electronic message, comprising sending the message from a sender to a message server, wherein the message server verifies the sender is a sending agent that is registered with the message server, decrypting a message header in the message to ascertain one or more recipients to receive the message, verifying the one or more recipients are recipient agents that are registered with the message server, and sending the message from the message server to the one or more recipient agents that are registered with the message server.

Another embodiment of the invention includes a method of transporting an electronic message comprising sending a first server-encrypted message from a sending agent to a message server, wherein the first server-encrypted message comprises a message header and encrypted message content that has been encrypted using a content key, and wherein the first server-encrypted message is encrypted using an sender message server key, ascertaining a recipient agent from the message header that has been decrypted using the sender message server key, wherein the encrypted message content is not decrypted at the message server, and sending a second server-encrypted message to the recipient agent where the second server-encrypted message is decrypted using a recipient message server key and the encrypted message content is decrypted using the content key.

Still another embodiment of the invention includes a method of controlling access to an electronic message comprising sending an access restriction message from a sending agent, wherein the access restriction message includes instructions to delete a content key used by a receiving agent to decrypt at least a portion of the electronic message, and deleting the content key, wherein the receiving agent can no longer decrypt said at least portion of the electronic message.

Still another embodiment of the invention includes a method of restricting transport of an electronic message comprising sending the electronic message from a sending agent to a message server, wherein the electronic message is addressed to one or more recipient agents, confirming by the message server that the sending agent and the one or more recipient agents are registered with the message server, wherein the electronic message is not sent to any of the one or more recipient agents if the sending agent is not registered, and sending the electronic message from the message server to the one or more recipient agents that are registered with the message server.

Additional novel features shall be set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE DRAWINGS

The invention will be better understood from a reading of the following detailed description in conjunction with the drawing figures, in which like reference designators are used to identify like elements and in which:

FIG. 1 illustrates a high-level block diagram of the overall system in which the Private Messaging capability of the present invention operates;

FIG. 2 illustrates a block diagram of a software program which can operate as an Agent for the Private Messaging capability in the system of the present invention;

FIG. 3 illustrates a block diagram of a software program and corresponding computer hardware which can operate as a Trusted Courier in the Private Messaging System of the present invention;

FIG. 4 illustrates a combination signaling sequence chart and flow chart for the Invitation to Register process in accordance with the present invention;

FIG. 5 illustrates a combination signaling sequence chart and flow chart for the Registration process in accordance with the present invention;

FIG. 6A through FIG. 6C illustrate a combination signaling sequence chart and flow chart for the Private Message process in accordance with the present invention;

FIG. 7 illustrates a combination signaling sequence chart and flow chart for the Key Replacement process in accordance with the present invention;

FIG. 8 illustrates a block diagram of a software program and corresponding computer hardware which can operate as an Interoperability Agent in the system of the present invention;

FIG. 9 illustrates a high-level block diagram of the overall system in which the Automatic Personal Information Updating capability of the present invention operates;

FIG. 10 illustrates a block diagram of a software program which can operate as an Agent for the Automatic Personal Information Updating capability in the system of the present invention;

FIG. 11 illustrates a combination signaling sequence chart and flow chart for the Information Update process in accordance with the present invention;

FIG. 12 illustrates a block diagram of a software program which can operate as a Proxy for Directory Devices in the system of the present invention;

FIG. 13 illustrates a block diagram of a software program and corresponding computer hardware which can operate as a Proxy Agent Server for Directory Devices in the system of the present invention;

FIG. 14 illustrates a block diagram of a software program and corresponding computer hardware which can operate as a Network Directory Proxy Agent Server in the system of the present invention;

FIG. 15 illustrates a high-level block diagram of the overall system in which the Automatic Appointment Coordination capability of the present invention operates;

FIG. 16 illustrates a block diagram of a software program which can operate as an Agent for the Automatic Appointment Coordination capability in the system of the present invention;

FIG. 17A through FIG. 17E illustrate a combination signaling sequence chart and flow chart for the Appointment Coordination process in accordance with the present invention;

FIG. 18 illustrates a block diagram of a software program and corresponding computer hardware which can operate as a Network Calendar Proxy Agent Server in the system of the present invention.

FIG. 19A through FIG. 19E illustrate a combination signaling sequence chart and flow chart for the Message Transfer process in accordance with the present invention;

FIG. 20A and FIG. 20B illustrate a combination signaling sequence chart and flow chart for the Message Recall procedure in accordance with the present invention;

FIG. 21A and FIG. 21B illustrate a combination signaling sequence chart and flow chart for the Access Restrictions Recovery procedure in accordance with the present invention; and

FIG. 22 illustrates a flow chart for the method of spam prevention in accordance with the present invention.

### DETAILED DESCRIPTION OF THE INVENTION

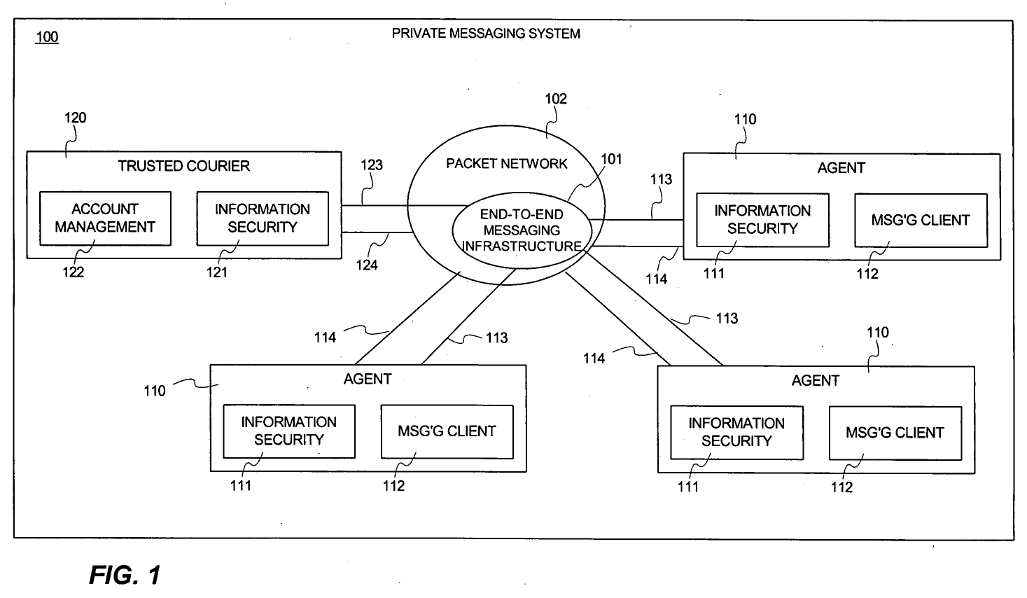

In the high-level diagram of FIG. 1, Private Messaging System 100 represents the system of the present invention. System 100 includes an End-to-End Messaging Infrastructure 101 that represents the messaging backbone to which the Private Messaging capability is added. This Infrastructure can be any messaging system that allows users or automatic programs to exchange messages with one another. It may be the Internet-standard email service, and may also be implemented as an instant messaging service, a wireless short message service (SMS), any other messaging service, or any combination of these. System 100 also includes Packet Network 102 that forms the foundation for communications among elements, including End-to-End Messaging Infrastructure 101 and the messages exchanged thereon, and also supports other non-messaging interactions such as web browsing. This element may be an Internet-based network, the Internet itself or another network like it, or a composite of networks using multiple interworking technologies.

Connected to End-to-End Messaging Infrastructure 101 and Packet Network 102 are one or more Agents 110, which are computer software applications and devices that enable the Private Messaging capability for an end user. Each Agent 110 may be a composite of some existing Messaging Client 112, an Information Security component 111, an interface 113 to the Messaging Infrastructure 101, and an interface 114 to the Packet Network 102. Messaging Client 112 is the users environment for composing, sending, receiving, reading, and storing messages.

Also connected to Message Infrastructure 101 and Packet Network 102 is a Trusted Courier 120. This element is a network server whose role is to relay Private Messages among users, which are represented by Agents 110. Thus Trusted Courier 120 also has an interface 123 to Messaging Infrastructure 101, an interface 124 to Packet Network 102, and an Information Security module 121 that embodies the methods of the present invention as detailed below. Because Trusted Courier 120 may act on behalf of a plurality of Agents 110, it may also include an Account Management component 122, wherein are registered those users who are permitted to operate the Private Messaging service.

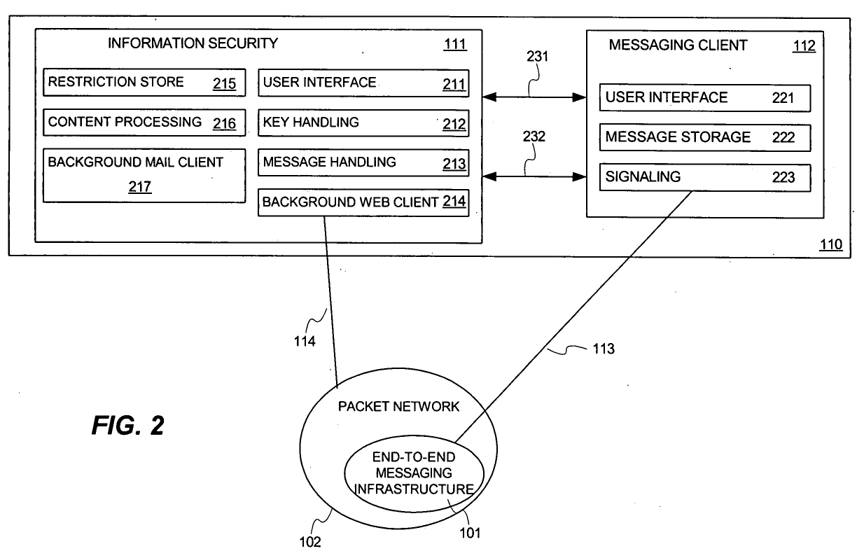

Further detail on Agent 110 is found in FIG. 2. In this example, Messaging Client 112 includes a User Interface module 221, which receives commands from and presents results to the user of Agent 110. Messages composed in and received through Messaging Client 112 are stored according to the user's needs in Message Storage module 222. Signaling module 223 provides protocol support for interacting with Messaging Infrastructure 101 via interface 113. This is where, in an embodiment based upon email for example, the Internet-standard messaging protocols Simple Message Transfer Protocol (SMTP) and Post Office Protocol (POP) would be implemented.

Information Security component 111 contains its own User Interface 211. This module provides additional commands and results that are specific to the Private Messaging capability, and will become clear as the methods of the present invention are further explained. Key Handling module 212 implements the cryptographic functions required to ensure messages are kept private in transit, including secure storage of encryption and signature keys.

Message Handling module 213 is responsible for message-based protocol interactions with Trusted Courier 120. Certain interactions between Agent 110 and Trusted Courier 120, specifically the initial direct exchange of cryptographic keys, are not message-based, and are instead implemented using a secure World-Wide Web (or simply web-based) interface technology. Background Web Client 214 is responsible for transporting these interactions, which will become clear as the methods of the present invention are explained below.

For each message sent or received by an Agent 110, information is required regarding its associated Access Restrictions, including in particular the encryption key used on the message content. The use and structure of the Access Restrictions data will become clear as the methods of the present invention are explained below. As specified in those methods, and particularly in order to effect the message recall capability, this information is stored apart from the message itself. As noted above, messages are stored in the Message Storage module 222 of Messaging Client 112. The corresponding Access Restrictions are stored in Restriction Storage module 215 of Information Security component 111.

In general, the content of a message to be sent through Private Messaging System 100 will comprise one or more blocks of information. Normally, at least one such block contains only text. Other blocks, if present in the message, generally contain copies of one or more files specified by the user. In order to convey these content blocks in a message, they must be formatted prior to encryption so as to preserve their structure. Content Processing module 216 is responsible for this formatting, of which more details will be given as the methods of the present invention are explained below.

Certain message-based interactions between Agent 110 and Trusted Courier 120, including in particular the conveyance of Access Restrictions for each Private or Restricted message but also others which will become clear as the methods of the present invention are explained below, are not directly meaningful to users and so are not passed through Messaging Client 112 and Messaging Infrastructure 101. Instead, direct messaging over Packet Network 102 is implemented by Background Mail Client 217. This module will support the POP and SMTP protocols independently, using an internal configuration with different server parameters and email address from that of Messaging Client 112.

The Information Security component 111 enhances the functionality of an existing Messaging Client 112, and the components interact inside Agent 110. This interaction generally takes the form of one or more Application Programming Interfaces (APIs) provided by the modules of existing implementations of Messaging Client 112. These APIs are represented by interfaces 231 and 232. Interface 231 provides a mechanism whereby User Interface 221 may be enhanced with additional commands and responses. User Interface 211 hooks to this API to provide its features. Interface 232 provides a mechanism whereby non-standard protocols or enhanced message handling capabilities may be added to Signaling module 223. Message Handling module 213 uses this API to intercept messages flowing in and out of Messaging Client 112 and provides special privacy-oriented handling.

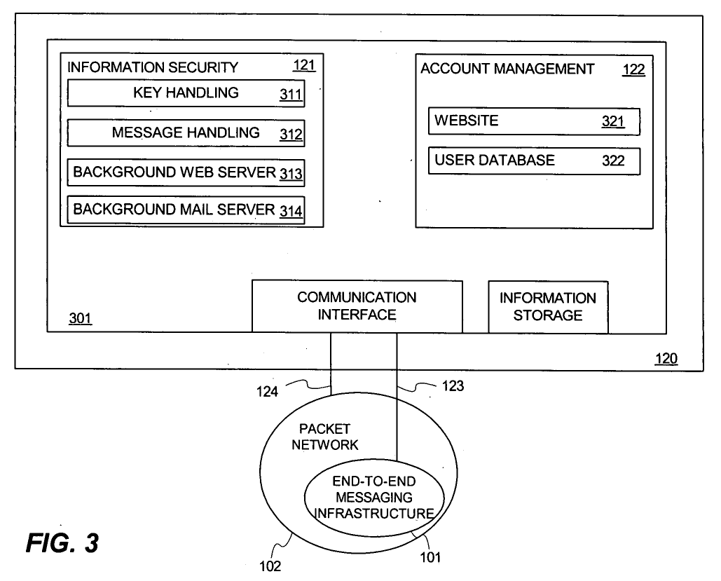

Further detail on Trusted Courier 120 is found in FIG. 3. Information Security component 121 is shown to be similar to Information Security component 111 in FIG. 2. In fact, the modules of these two components may be mirror images of one another. Specifically, Key Handling module 311 implements the cryptographic functions that ensure messages are kept private in transit, including secure storage of encryption and signature keys. Message Handling module 312 is responsible for message-based protocol interactions with Agent 110, which will become clear as the methods of the present invention are further explained. Certain interactions with Agent 110, such as the direct exchange of cryptographic keys, are not message-based, and may be instead implemented using a secure World-Wide Web (or simply web-based) interface technology. Background Web Server 313 is responsible for these interactions. Note that Information Security component 121 has no User Interface module, unlike its counterpart in Agent 110. This is due to the fact that Trusted Courier 120 is a network server, which operates on behalf of numerous users rather than being dedicated to a single user.

Users interact with Trusted Courier 120 to establish an account. This interaction is the responsibility of the Account Management component 122 and its Website module 321. The accounts themselves may be stored in the User Database module 322. These modules are designed to be implemented using common, well-known software applications. For example, Website 321 may be based on the Apache web server application, and User Database 322 may be based on the PostgreSQL database toolkit. In each case, customizations specific to the needs of the Private Messaging service and Trusted Courier 120 may be used.

Where Agent 110 may generally be implemented in a variety of ways using several different Messaging Clients 112 on numerous different hardware and operating system platforms, and therefore is shown as software functionality in FIG. 2, Trusted Courier 120 is designed to operate as a server, and so is depicted in FIG. 3 with a specific Programmable Computing Platform 301. Platform 301 is chosen to provide highly reliable operation and flexible scalability. Conventional candidates satisfying such requirements are available from major vendors such as SUN, HP, Motorola, and Intel.

Platform 301 also includes a Communication Interface 302 for connecting to a network. This may be implemented using two or more standard Ethernet links. Additionally, Platform includes an Information Storage medium 303, for holding the data for components Information Security 121 and Account Management 122. This may be implemented as a magnetic “hard disk” module.

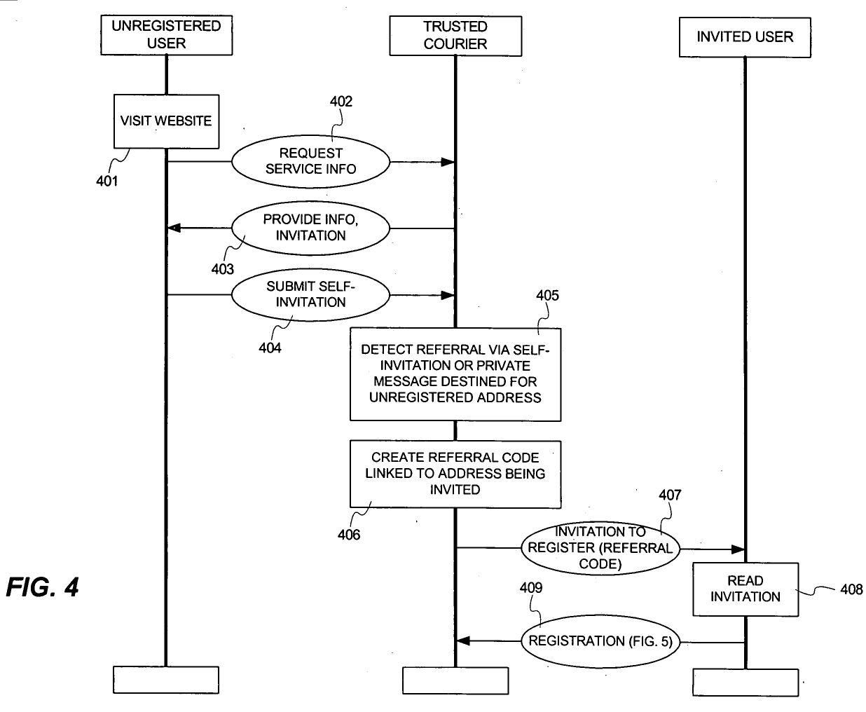

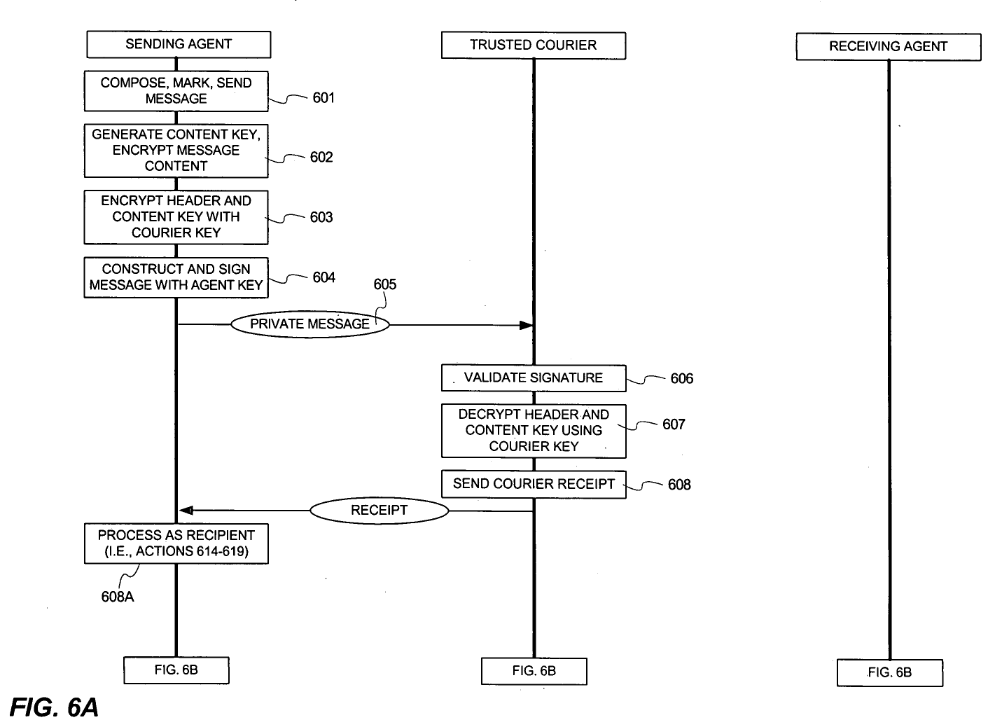

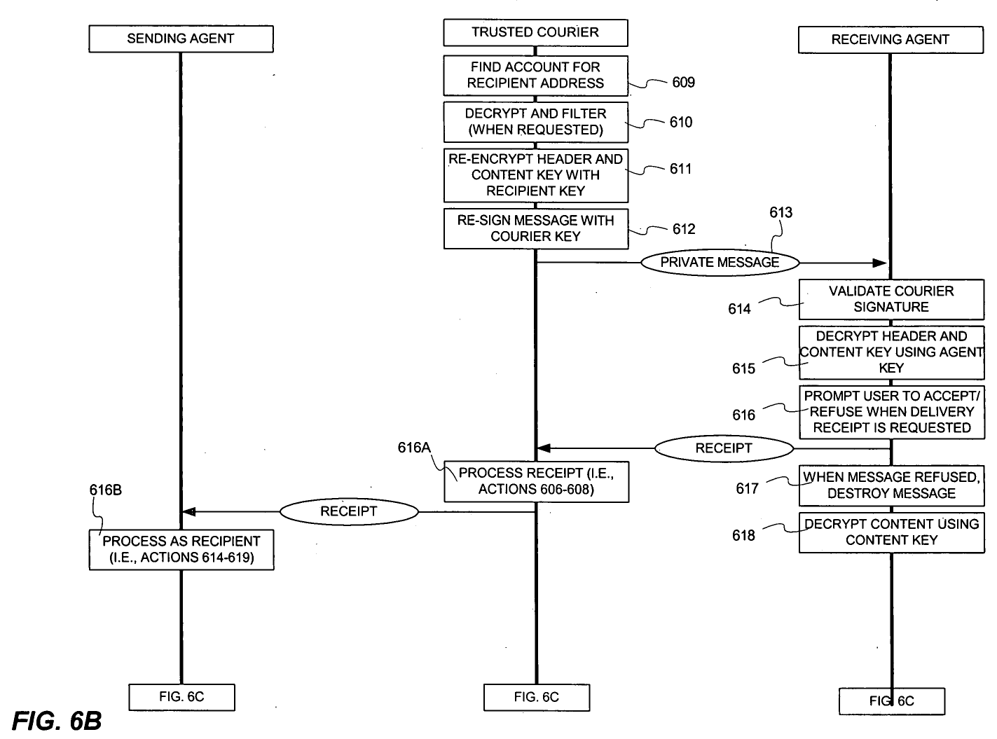

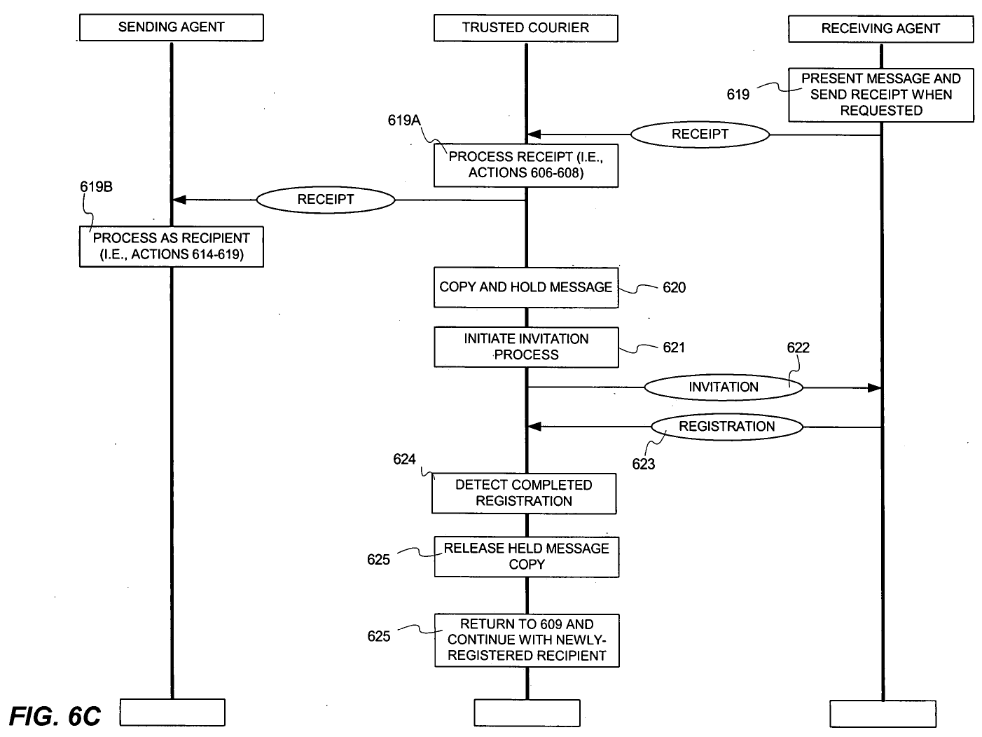

In FIG. 4 through FIG. 7 illustrate four methods that are implemented on the Private Messaging system. FIG. 4 shows the method of inviting users into the system. Invitations may be issued to the addresses of Private Message recipients who are not already registered in the system, and who therefore are unable to receive and decipher such a message sent to them by someone who is so registered. Referring to FIG. 4, the Invitation to Register process begins at step 405, in which Trusted Courier 120 becomes aware of an unregistered messaging address. As stated previously, this may occur during handling of a Private Message, which is described in the context of FIG. 6. However, because this mechanism may not reach everyone who may wish to register for the Private Messaging system, an additional mechanism allows such people to invite themselves. This self-invitation mechanism is shown in FIG. 4 beginning at step 401, in which an individual visits the Trusted Courier's website to learn more about the service and sign up.

Self-invitation continues in step 402, wherein the prospective new user's web browser sends a request for service information to Trusted Courier 120's Website 321. In step 403, Website 321 responds by sending a web page containing service information and a Self-Invitation Form to the prospective user's browser. When the prospect is satisfied with the information and ready to sign up, he or she will enter a messaging address into the form and submit it at step 404. Thus concludes the self-invitation.

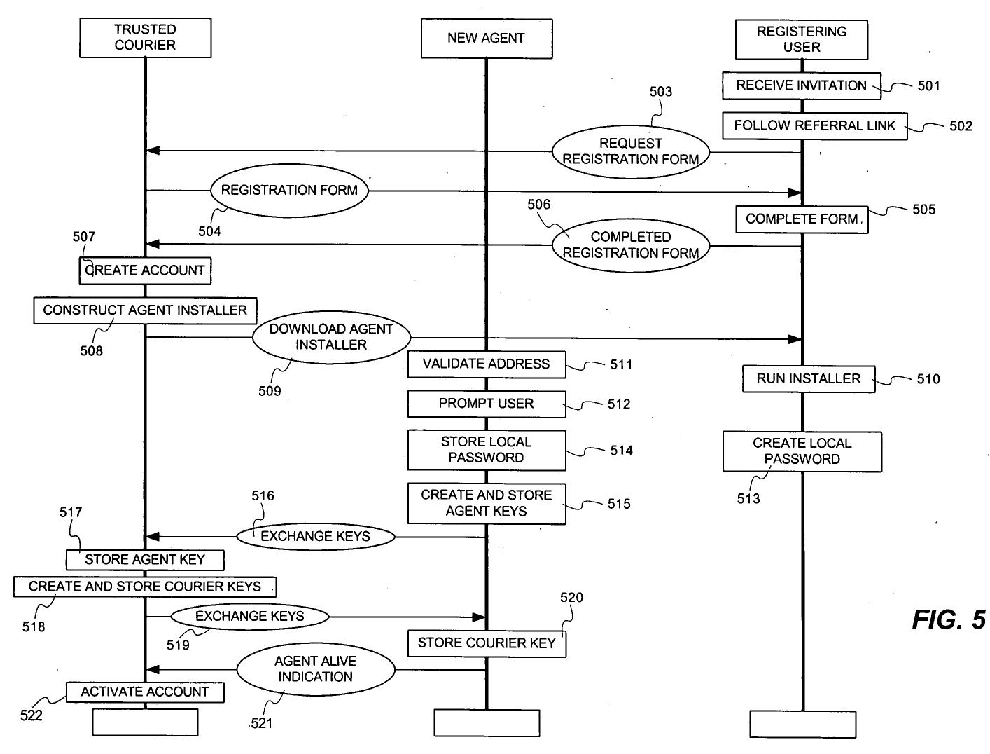

The Invitation to Register process commences at step 405 with Trusted Courier 120 becoming aware of an unregistered messaging address, whether via a Private Message or a Self-Invitation. In step 406, a referral code is created and placed in a message inviting the user to register, which is sent at step 407 and read by the user at step 408. This referral code will come back to Trusted Courier 120 during the Registration process, as explained in the context of FIG. 5 and shown here in abbreviated form as step 409, in order to identify the registering user without requiring or allowing said user to re-enter his or her address. The invitation process, by sending a message to the invited address, ensures that a registering user can in fact receive messages at the claimed address. This prevents fraudulent attempts to register another person's messaging address and thereby impersonate that individual.

Turning now to FIG. 5, the Registration process is responsible for registering users so that they may operate an Agent 110 and interact successfully with Trusted Courier 120 to exchange private messages with others. This process is sensitive to security issues, as it is used to establish a user's identity and exchange cryptographic keys.

Registration begins with step 501, in which the registering user receives an Invitation as described in the context of FIG. 4. Imbedded in the Invitation message is a referral link, implemented as a Universal Resource Locator (URL) pointing to Website 321 of Trusted Courier 120 and conveying the referral code. In step 502 the user follows this link. This may be accomplished using a point-and-click mechanism as provided by common computer operating environments, which automatically copies the link out of the message into a Web Browser application. However, a user may copy the URL into a browser by hand or use any other appropriate technology. However the URL may be entered, it causes a request packet to be sent at step 503, asking Website 321 for a Registration Form and carrying the referral code received in the Invitation. The referral code creates a link between the Invitation and the Registration such that exposure to fraud is reduced.

It is recommended that step 503, as well as other interactions with Website 321, be performed in a secured environment. For example, the user's browser and Website 321 are communicating via an encrypted protocol such as the Secure Sockets Layer (SSL) so that private information is not exposed in transit. In a non-secure environment, Trusted Courier 120 may not be able to guarantee message privacy and user identity in future procedures.

The registration form presented in step 504, as requested in step 503, asks the user for information necessary to establish an account in Trusted Courier 120. The user will see in the form the messaging address, which in an embodiment would be a working email address that was originally Invited and may become the user's identity within the Private Messaging system. Note that messaging addresses may, but do not necessarily, include enough information to provide a user's actual identity. Therefore, the Private Messaging system of the present invention does not prevent user anonymity if it is allowed by the underlying messaging system. This item will not be entered again by the user, and cannot be changed in the form, thus preventing fraudulent registration using someone else's address. The user creates and enters an account password known by the user, which prevents unauthorized users from accessing the user's account in Trusted Courier 120. The account password may be used to validate the user's identity when making account changes or complaining of faulty system behavior, either via Website 321 or by telephone.

The user may also enter identifying and non-messaging contact information so that notices and, if appropriate, invoices may be delivered if the messaging address stops working. These items are entered into the form at step 505, and transmitted to Trusted Courier 120 at step 506.

Upon receipt of the completed form in step 506, Trusted Courier 120 will at step 507 create the user's account, by allocating an entry in User Database 322 and recording the users information there. Next, at step 508 Trusted Courier 120 will construct an Agent Installer for the user. The Agent Installer is a software application that will install an Agent 110 in the user's computer or device.

Because Messaging Client 112 already exists, the Agent Installer package includes code for Information Security module 111 with interfaces 231 and 232 suitable for the user's actual Messaging Client 112, along with a one-way hash of the user's messaging address, and the messaging address to be used when sending messages to Trusted Courier 120. The package may be downloaded to the user's computer or device in step 509 through the same secure path used by the registration form in steps 503 through 506.

After downloading the Agent Installer, the user executes it at step 510 to create Agent 110. The precise events in the execution depend on the user's operating system, and may take the form of opening a file via a graphical user interface, typing the name of a file in an executive, or some other mechanism. For example, if the user is using a web browser to interact with Trusted Courier 120, the Agent Installer may execute automatically upon downloading, as if it were another web page. The Agent 110 itself, once installed, does not have to execute in this manner: It may, for example, operate either as two standalone applications (Information Security 111 and Messaging Client 112), or as a single integrated application (Messaging Client 112 with Information Security 111 imbedded within), depending upon implementation choices and the specific Messaging Client 112 being used.

During installation, the installer establishes that it has landed in the right place, so its first action at step 511 may be to examine the configuration of Messaging Client 112 and find the user's messaging address. This address may then be run through the same one-way hash function that Trusted Courier 120 used to create the hashed address it placed in the installer at step 508, and the two hashes may be compared. If they match, the installer will have validated its arrival location; and if not, the Agent 110 cannot be correctly formed and installer may exit unsuccessfully. This prevents a malicious user from attempting to copy or move the installer to another machine and use it to create an Agent 110 for a fraudulent address.

Once validated, the Agent Installer will bind Information Security module 111 to Messaging Client 112 to form Agent 110, start the appropriate program, and exit itself. Agent 110 will at step 512 demand that the user create and enter a local password. This local password serves to ensure in the future that only this user can run Agent 110 and launch private messages with it. The local password does not have to be shared with Trusted Courier 120, although the user certainly could choose to use the same phrase for both the account password and the local password. The user enters the local password at step 513, and Agent 110 stores it in step 514. Note that Agent 110 is implemented in such a way that its code is difficult to copy to another machine, such as by distributing it among multiple files in obscure locations. It is also implemented so that if the computer or device in which it is running crashes during initialization (steps 511-519), or if the initialization process is intentionally terminated in an attempt to compromise the integrity of the registration process, the state of the program will be destroyed and subsequent starts of Agent 110 will commence initialization from the beginning again, repeating the address validation.

Agent 110 and Trusted Courier 120, or more specifically Key Handling modules 211 and 311, will each create cryptographic keys using a Public Key algorithm that produces a pair usable for both signature and encryption. That is, each side will create one key with which it can sign messages it sends and decrypt messages it receives, and another key with which the other side will validate the signature on messages it receives and encrypt messages it sends.

For example, a known RSA public-key encryption and signature algorithms may be used. In usual practice, the encryption/signature-validation key for each side is considered public, and is shared with all correspondents; the present invention instead keeps it secret within the opposite element, either Trusted Courier 120 or Agent 110 as appropriate. This practice can simplify private messaging: Agent 110 is required to know the encryption/signature-validation key for only a single correspondent, Trusted Courier 120, and shares its own encryption/signature-validation key with only one correspondent, again Trusted Courier 120. It should also be noted that, again unlike in a typical public-key system, Trusted Courier 120 uses multiple key pairs for itself, sharing a different “public” key with each registered Agent 110. This simplifies key management in the system as a whole; in the event of a single Agent 110 compromising Trusted Courier 120's “public” key, only that Agent should be rekeyed, not all of them. It may be argued that with both decryption/signature and encryption/signature-validation keys being secret, a symmetric encryption technique would suffice. As has been stated the present invention is not restricted to using RSA signatures; other implementations using other encryption/signature protocols fall within the scope of the invention. However, the remainder of the invention will be described using the RSA approach.

The first step in establishing the keys, step 515 of the Registration process, is for Agent 110 to create its key pair, using techniques known to those skilled in the art. Agent 110, specifically Restricted Web Client 214, will create a secure link to Trusted Courier 120, specifically Restricted Web Server 313, using the same SSL techniques used previously for the user's interaction with Website 321. Within the secure link, Agent 110 may then send to Trusted Courier 120 in step 516 the messaging address account identifier and Agent 110's “public” encryption/signature-validation key. Upon receiving the Agent's key, Trusted Courier 120 may store it in step 517, create its own key pair in step 518, and send its encryption/signature-validation key back to Agent. 110's installer in step 519 through the same secure link. During step 518, Trusted Courier 120 will also sign the Agent's key to form a certificate, also to be sent back during step 519, thereby providing proof that the keys were correctly exchanged. At step 520, the Agent Installer stores the key and certificate returned by Trusted Courier 120;

With the keys now exchanged and stored in complete confidence, the secure link is disabled. Agent 110 informs Trusted Courier 120 that it has been installed completely and correctly. It does this by sending a message, encrypted and signed using the keys just exchanged, to Trusted Courier 120 at its messaging address as configured in Agent 110 at step 508. Step 521 of FIG. 5 depicts this message as an “Agent Alive Indication.” Upon receiving the Agent Alive Indication message, Trusted Courier 120 will at step 522 activate the user's account.

Now that the user's account is active, private messages may be created and sent to correspondents via Trusted Courier 120. FIG. 6 shows an example of how this can be done. First, at step 601 the sending user will compose the message, mark it as private, and command Agent 110 to send it. Note that Messaging Client 112 allows the user to compose and send non-private messages, just as it could before being combined with Information Security 111 to make Agent 110. As an option, implementations of Agent 110 may automatically treat all messages as private to simplify this step.

At this point, Information Security module 111 takes over the message. In step 602, it generates a one-time-use symmetric encryption key and uses it to encrypt the message content: the body and any attachments.

In step 603, Agent 110 uses its decryption/signature key (also known as the “private” key in an “public-key” cryptography algorithm) to create a signature over the end-to-end parts of the message header, which includes the “Subject:” field and those messaging addresses identified as the “To:” and “CC:” recipients, but excluding those messaging addresses identified as the “Bcc:” recipients; the symmetrically encrypted message content; and the symmetric encryption key used to encrypt the message content. The “Bcc:” recipients are excluded because they are not delivered to the recipients; however, they will be included in the message for handling at Trusted Courier 120.

In step 604, the signed data and its signature, along with the list of “Bcc:” recipients if there is one, are composed into the body of a message addressed to Trusted Courier 120. This body is then signed and encrypted according to the S/MIME email encryption standard (IETF document RFC 1847) for complete protection during transport to Trusted Courier 120. In accordance with this standard, the message body is signed using the sender's private key (that is, the decryption/signature key in this case), a symmetric encryption key is chosen (in this case, a different key than was used to encrypt the actual message body), the message is encrypted with that key, and that key is encrypted using the recipient's public key (in this case Trusted Courier 120's encryption/signature validation key).

Note that after the rounds of encrypting, not only is the original message body protected, but so is the original message header. Also note that, with multiple signatures imbedded in the message at this point, the message can be authenticated both to Trusted Courier 120, and to the receiving Agent 110. In fact, the sender's signature over both encrypted body and header, delivered intact to the recipients, can be revalidated at a later date by Trusted Courier 120 if necessary, thus effecting an electronic notary service.

In step 605 the message is sent to Trusted Courier 120; this includes wrapping the message in a message envelope noting the Trusted Courier's messaging address as the recipient rather than the true recipients' addresses. Upon arrival of the message at Trusted Courier 120, at step 606 the sender's address is used to retrieve an account entry from User Database 322. The decryption/signature key used by Trusted Courier 120 for messages from the sender is used to decrypt the S/MIME transport encryption key. This key is in turn used to decrypt the transport package and recover the signatures, headers, and end-to-end encrypted message content.

In step 607, Trusted Courier 120 uses the sender's Agent's encryption/signature-validation key to authenticate the two signatures in the message, and if either of them fails the message is discarded. While a log entry may note the event, no message is sent to any address associated with the message in order to avoid creating an avalanche. Assuming the signatures validate correctly, the message headers can now be examined. If the header includes a request from the sender for a Courier Receipt, Trusted Courier 120 at this point, step 608, constructs, encrypts, and signs a message to the sender acknowledging receipt of the message.

Now Trusted Courier 120 steps through the list of recipients' addresses in the header, determining which refer to registered users and which are unregistered. The next several steps occur for each registered addressee.

In step 609, the account for the registered addressee is retrieved from User Database 322. Step 610 describes the content screening supplementary service to which users may subscribe. Under normal circumstances Trusted Courier 120 does not decrypt the message content, and does not implement the symmetric encryption algorithm required to act upon the one-time key covering the content. However, recipients may delegate to Trusted Courier 120 the right to decrypt the message and filter it for undesirable content prior to forwarding.

Examples of undesirable content for which this capability may screen include attached or imbedded malware, such as wormy, viral, or trojan code; pornographic material; or unsolicited commercial messages. If undesirable content is detected, at the user's preference it may be removed from the message and the message re-encrypted, or the message may be discarded entirely. Header screening, though not requiring message decryption, may also be implemented at this step, thus allowing a user to specify senders from which messages are never accepted.

Now the message can be prepared for relaying to the recipient. At step 611, the original end-to-end package (header without Bcc: list, end-to-end encryption key, content, and sender's signature) is signed with the decryption/signature key Trusted Courier 120 uses for communication with the recipient's Agent 110. The S/MIME transport encryption is applied in step 612 for transport to the recipient user. Ready to be relayed, the signed package is wrapped in a message from Trusted Courier 120 to the recipient's Agent 110 at step 613.

Upon the message's arrival at the receiving Agent 110, in step 614 Agent 110 may recover the original package by reversing the S/MIME transport encryption. For example, using its decryption/signature key the receiving Agent 110 decrypts the S/MIME transport key and in turn uses the transport key to decrypt the message. Agent 110 validates Trusted Courier 120's signature using its encryption/signature-validation key in step 615, using the appropriate keys. Now the original header, the encrypted content, the end-to-end encryption key, and the sender's signature are all available. Note that the sender's signature is not usable directly by the recipient, because only Trusted Courier 120 has the corresponding key. If validation is required at some point, a request to do so may be submitted to Trusted Courier 120. Also note that the “Bcc:” list is not present; this is in accordance with the normal processing of Bcc: addressees, which are not provided to recipients.

At step 616, if the header indicates a request from the sender for a Delivery Receipt—for example, a notification message signifying the original message had arrived at the receiving Agent—the receiving user is prompted to either accept the message or refuse delivery. This allows the recipient an opportunity to recognize the sender and reject the message (perhaps it's a collection notice, a subpoena, or an information package ordered C.O.D. but no longer wanted). Note that only messages with Delivery Receipt requested can be refused, because to prompt for refusal on every message is onerous, the next opportunity to act would be upon the message being read, and once a message is read it makes no sense to allow it to be refused. Therefore, a refusal opportunity for the recipient may occur if the sender values the message highly enough to want a receipt.

In any case, if Delivery Receipt is requested, step 616 is shown sending a receipt message, either delivery or refusal, to the sender through the Courier. Steps 616a and 616b indicate that the receipt message is processed like any other message. If the recipient actually does refuse to accept a message, after the receipt is sent the message will be destroyed in step 617.

Assuming the message either was not refused or not given an opportunity to be refused, the receiving Agent 110 will proceed to decrypt the message content using the one-time key at step 618, and present it to the user at step 619. Also in step 619, if the header indicates the sender requested a Presentation Receipt, which is similar in concept to the Read Receipt, Agent 110 will construct, encrypt, and send a message acknowledging presentation of the message. This receipt is in turn processed as any other message in steps 619a and 619b

This concludes the processing for a registered recipient's address. Again, as noted above, the preceding steps are executed for each registered recipient in the message header.

Now the unregistered addresses in the header are handled. This service does not discard from the sender's recipient list those addresses which it does not know, nor can it simply decrypt the message and send it along. Rather, it attempts to bring those unknown users into the system so they may receive the message privately as intended. This is where the Private Message process interacts with the Invitation and Registration processes. The next several steps occur for each unregistered address in the message header.

First, at step 620, Trusted Courier 120 makes and stores a copy of the message: Decrypted header and one-time key, sender's signature, and encrypted content. Then, at step 621 it initiates the Invitation to Register process described above in the context of FIG. 4, giving it the messaging address to which the invitation should be sent. Steps 622 and 623 depict, in abbreviated form, the Invitation and Registration processes which will follow. Once Registration is complete, at step 624 Trusted Courier 120 will notice that the previously unregistered address is now registered. It will then, at step 625, release the stored message copy for that address and, at step 626, return to step 609 to relay the message to the newly-registered recipient.

This concludes the processing for an unregistered recipient's address. Again, as noted above, the preceding steps are executed for each unregistered recipient in the message's header. Once the message has been delivered to all such recipient's, assuming they all register, processing is complete for the message. Note that an implementation will, as part of good server hygiene practice, purge outstanding messages stored while awaiting registration by an unregistered user after a certain period. Whenever such a purge occurs, a non-delivery notice message should be sent to the original sender of each purged message.

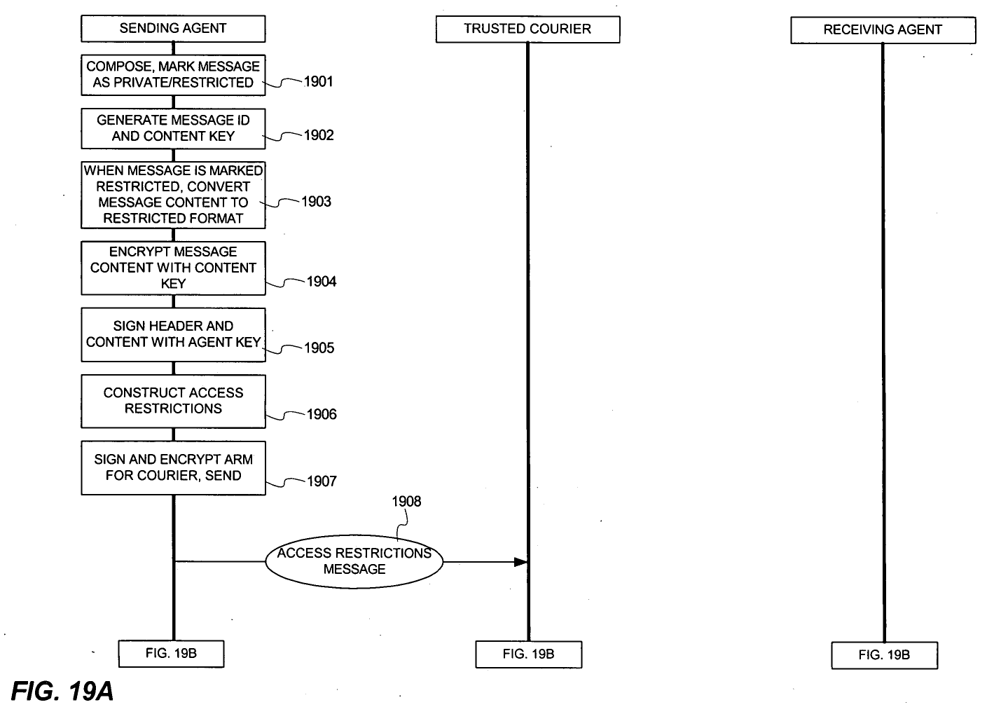

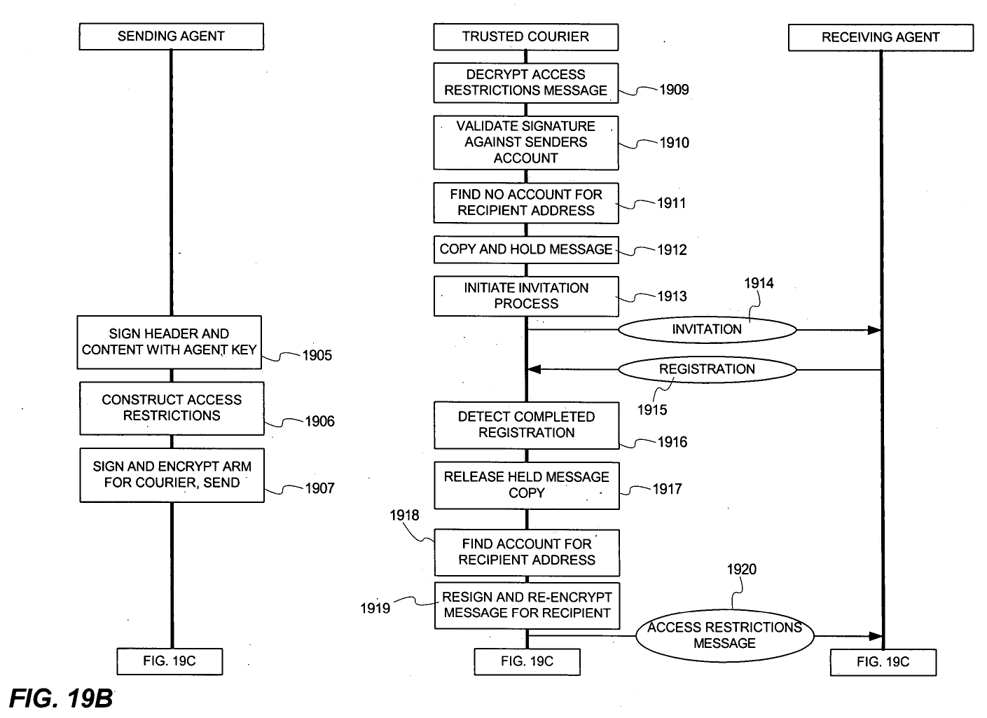

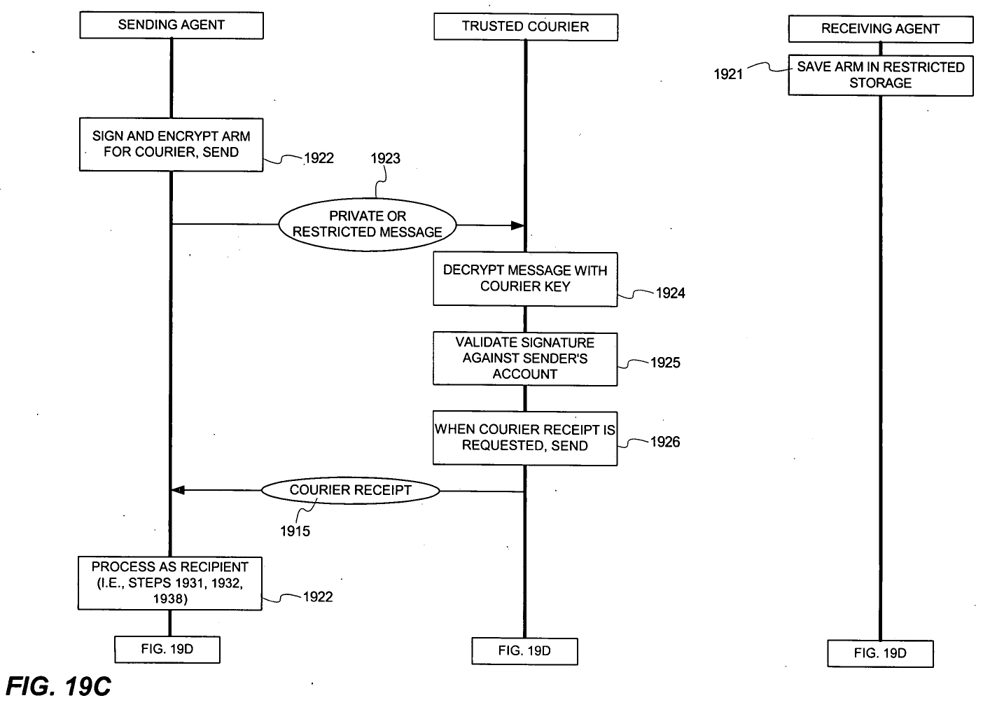

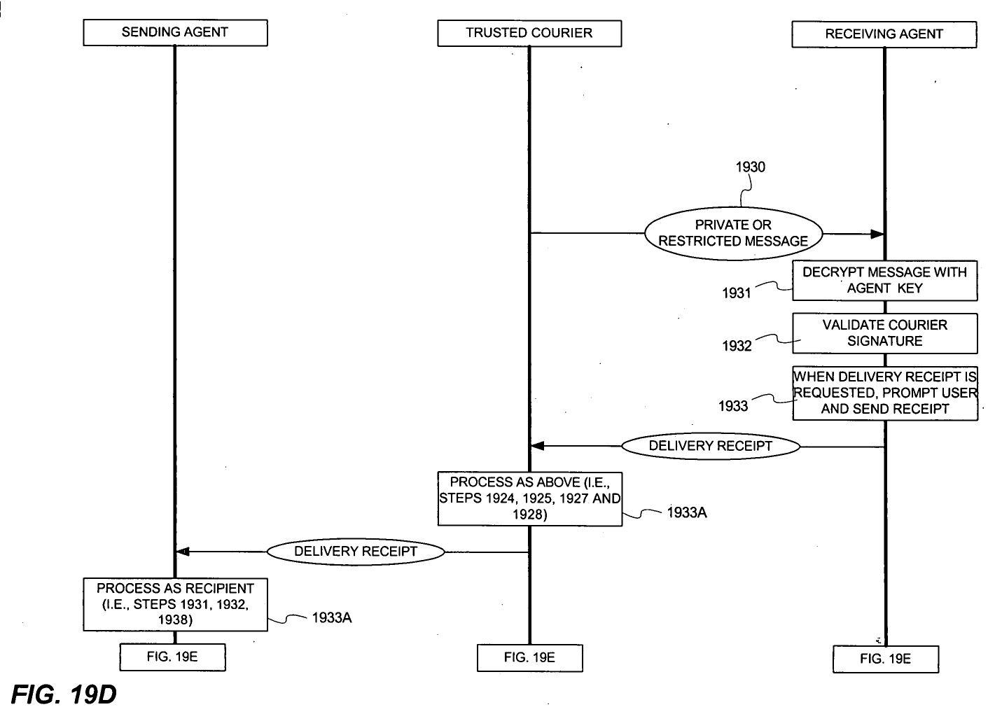

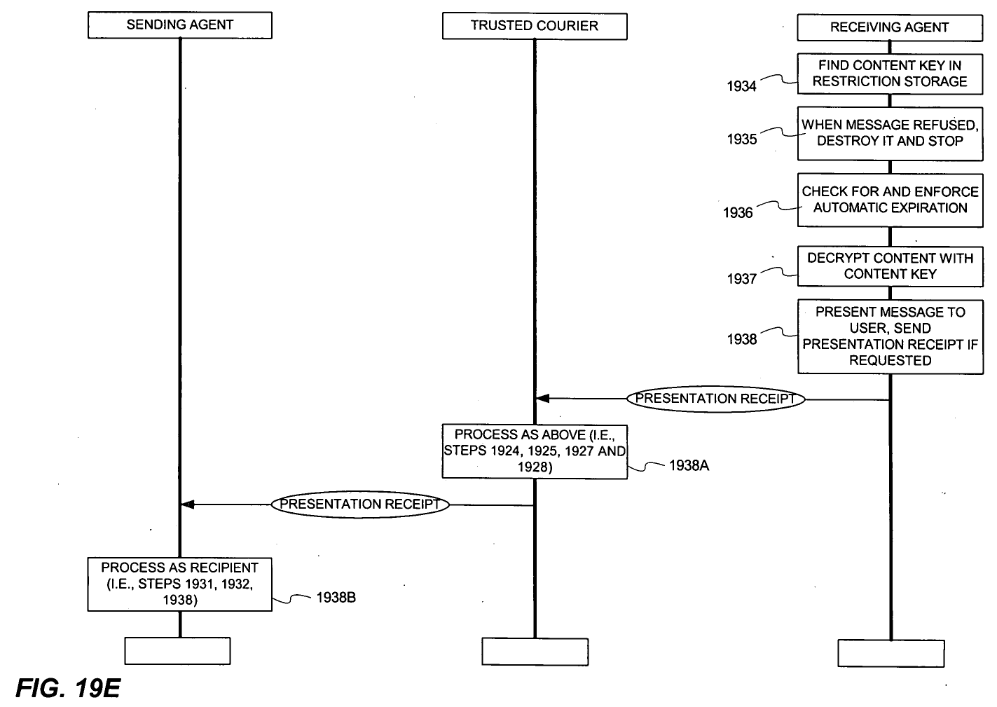

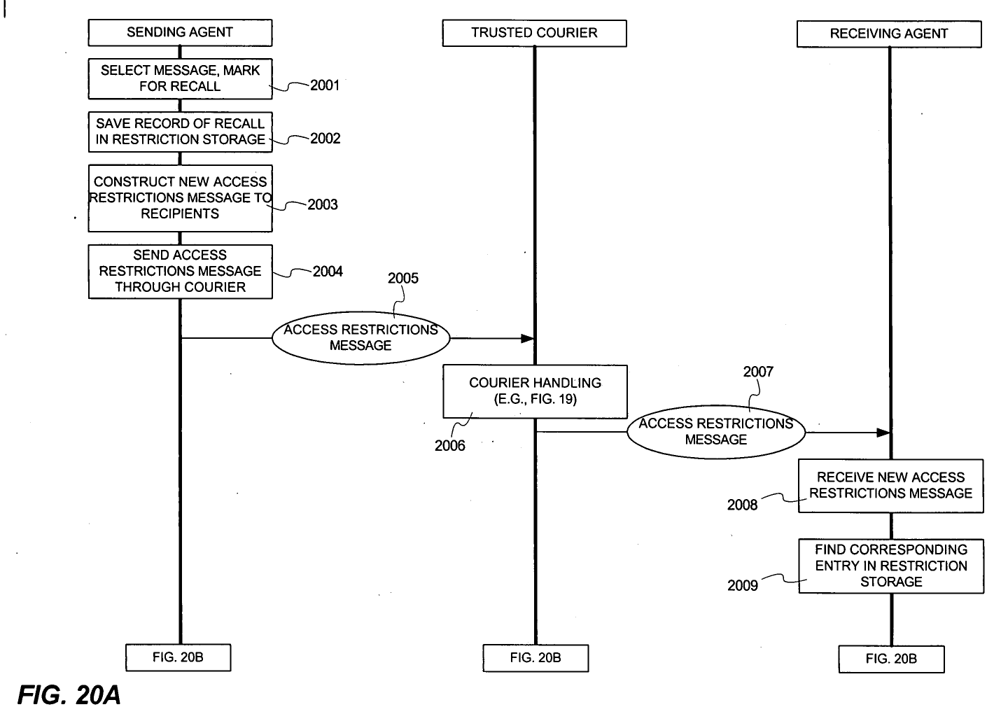

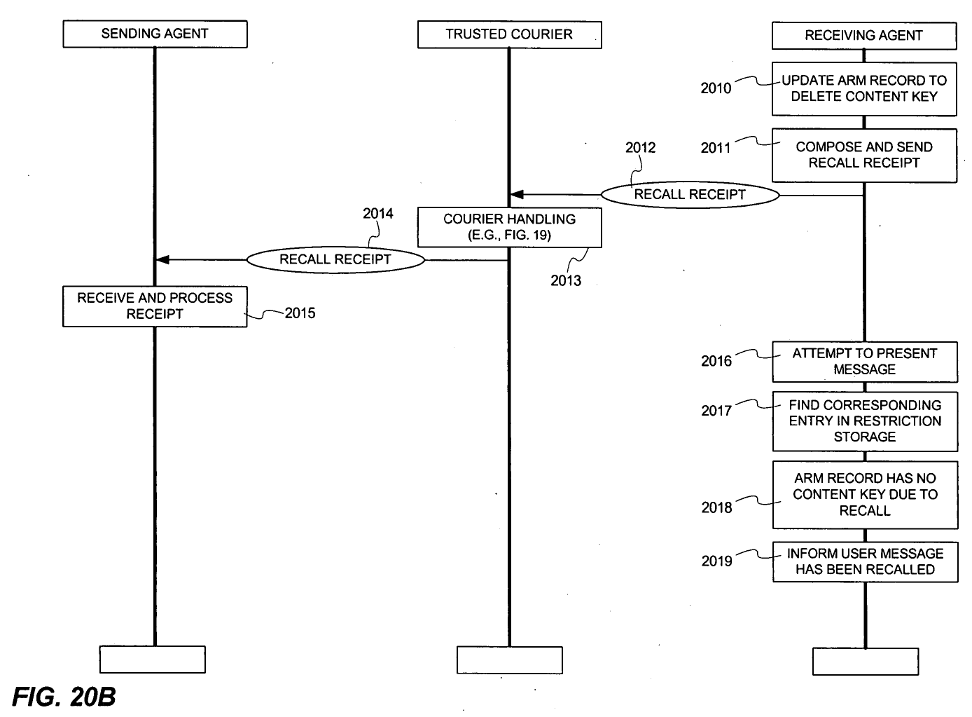

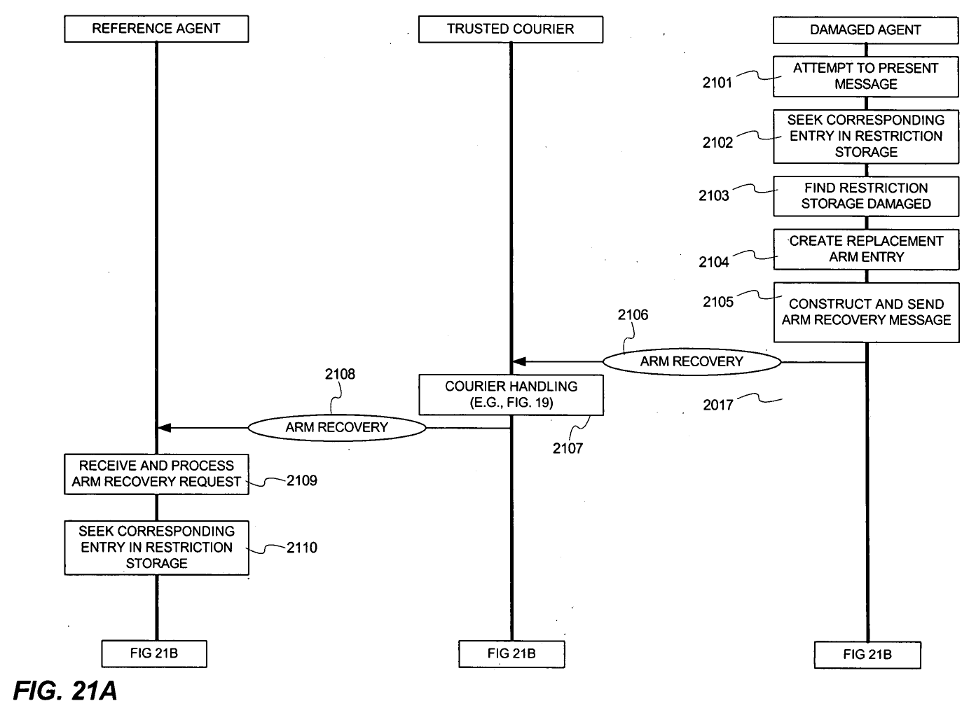

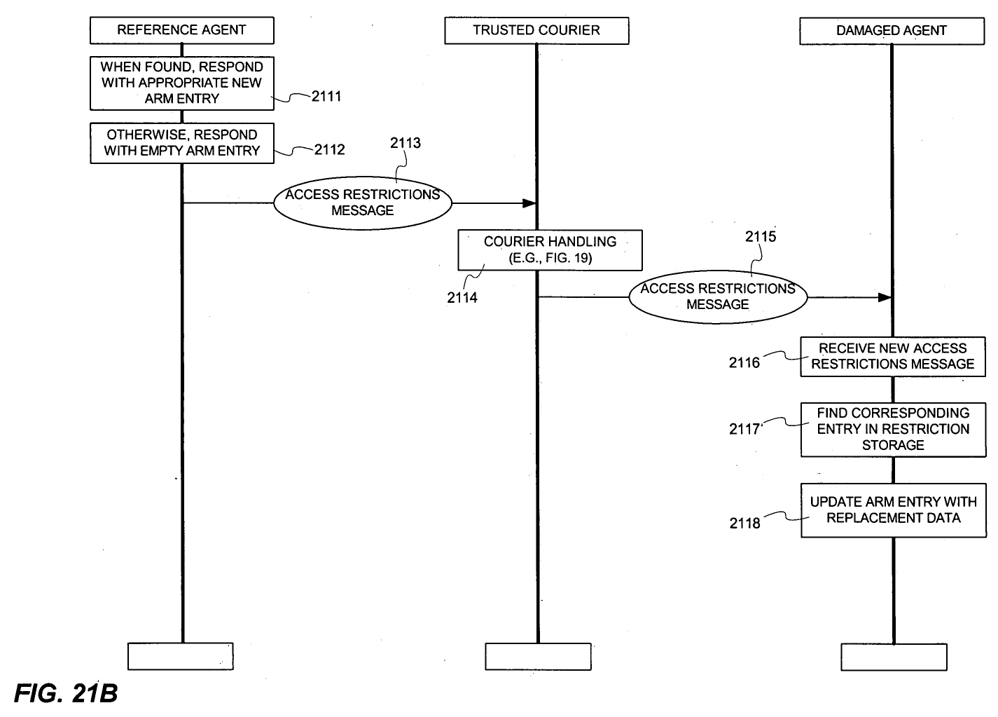

An alternative message transfer process is illustrated with reference to FIG. 19, which occurs at the completion of the registration process described in the context of FIG. 5, the user's account is active and Private or Restricted messages may be created and sent to correspondents via Trusted Courier 120. FIG. 19, which due to space limitations on a single page has been divided into FIGS. 19A through 19E, depicts the process which is followed to do so. First, at step 1901 the sending user will compose the message, mark it as Private or Restricted as appropriate, and command Agent 110 to send it. Note that Messaging Client 112 allows the user to compose and send ordinary messages that are neither Private nor Restricted, just as it could before being combined with Information Security module 111 to make Agent 110. Hence the need to be explicit about marking the message. In an embodiment, User Interface module 211 adds two buttons, Send Private and Send Restricted, to User Interface 221 to support the aforementioned marking. As an option, implementations of Agent 110 may choose to treat all messages as Private to simplify this step further. While an option to treat all messages as Restricted might also be implemented, such an option is not preferred.

At this point Information Security module 111 takes over the message. In step 1902, it generates data items which will apply uniquely to this message. First, Agent 110 creates a globally unique Message Identifier (ID), which will stay with the message and allow later references to it. Global uniqueness can be achieved by applying to this value one of the common techniques for satisfying the uniqueness requirement in the standard RFC822 MessageID field; though the Message ID specified here is distinct from that standard field, it serves the same purpose within Private Messaging System 100 as the RFC822 MessageID does for standard email.

Second, Agent 110 creates a one-time-use symmetric encryption key, referred to as the Content Key, which will be used to encrypt the message content: the body and any attachments. For a Private message, the length of the Content Key will depend on the requirements and capabilities of the specific encryption algorithm chosen for the message. For a Restricted message, the length of the Content Key will be determined by the requirements and capabilities of the restricted format chosen for the message. In either case, to the extent that variable-length keys are possible Agent 110 will generate Content Keys of at least 128 bits, and preferably 256 bits when possible.

Choice of the specific encryption algorithm and restricted format are implementation decisions, which are likely to change throughout the life of the system as encryption and access restriction technologies evolve. The present invention does not create a new encryption algorithm, but instead will utilize proven algorithms existing at the time of implementation or coming into existence during the life of the system. Similarly, neither does the present invention create a new restricted data format, but instead will utilize proven combinations of format and viewer existing at the time of implementation or coming into existence during the life of the system.

After generating the Message ID and Content Key, those two items and any expiration date the user may have set for the message are formed into a data structure called an Access Restrictions Management Record (ARM Record for short), and stored in Restriction Storage module 215 for future reference. Storing the ARM Record separately ensures the message can only be decrypted by the user in case messages are stored in a server accessible to others.

With those preliminaries complete, processing of the message itself can begin. If the user originally marked the message as Restricted in step 1901, its content is reformatted at step 1903 so that the information cannot be copied, printed, saved, or otherwise effectively extracted. Content Processing module 215 implements this message content reformatting as necessary, converting to the protected format when preparing a Restricted message to send, and displaying Restricted messages which are received.

While it is possible to create and use a new document format for Restricted messages, it is the intent of the present invention that any format may be used which is capable of capturing and protecting the majority of file types likely to be attached to a message, as well as the textual portion of the message itself. In one embodiment, Restricted messages may be protected using the Portable Document Format (PDF), which provides password-protected access to textual and graphical information, with well-defined restrictions on use including control of the ability to copy and print. The usual technique for reformatting an arbitrary file into PDF, well-known to those skilled in the art, is to use the file's native application to print it while specifying a printer driver that is especially designed to write out the information as a PDF file. Such formatting tools, as well as presentation tools, are widely available for PDF, and may easily be integrated into Content Processing module 215.

In an alternate embodiment, Restricted messages may be converted to Postscript, compressed, and presented using a dedicated viewer program which provides no ability to extract content. Encryption identical to that used for Private messages applies in this embodiment to Restricted messages as well. The usual technique for reformatting an arbitrary file into Postscript is also well known to those skilled in the art, and again involves using the file's native application to print it while specifying a printer driver that is especially designed to write out the information as a file containing Postscript commands. Here, too, formatting and presentation tools are readily available and easily adapted to Content Processing module 215. Finally, future alternate embodiments may make use of the emerging Extensible Rights Markup Language (XrML), as appropriate tools become widely available.

In reformatting the content of a Restricted message, the message header, subject, and body text are treated as one content segment and become one Restricted content file attached to the message. Additional attachments are each converted into the Restricted format separately, and attached to the message. In an embodiment using PDF, every file composing the message has its restriction flags set to prevent printing, copying, and modifying, and the Content Key generated in step 1902 is used as the file password for each. In the alternate embodiment using Postscript, no special flags are used since the prohibitions are inherent in the dedicated viewer program used as a presentation mechanism.

At step 1904, the message content is encrypted using the Content Key generated in step 1902. If the message is to be Private, the entire content including body and attachments is encrypted as a single block using an established algorithm. In an embodiment, the standard Advanced Encryption System (AES) algorithm is used; however, as encryption technology advances during the lifetime of Private Messaging System 100, other algorithms may be incorporated to create alternate embodiments. If the message is to be Restricted, each of the files generated in step 1903 is encrypted, using the Content Key as file password, according to the restricted-format standard—RC4 in an embodiment using PDF, the same encryption used for Private messages in the alternate embodiment using Postscript.

In step 1905, Agent 110 uses its decryption/signing key (also known as the “private” key in a “public-key” cryptography algorithm) to create a signature over the symmetrically encrypted message content and the end-to-end parts of the message header, which includes the Message ID created in step 1902, the “Subject:” field, and those messaging addresses identified as the “To:” and “CC:” recipients, but excludes those messaging addresses identified as the “Bcc:” recipients. The “Bcc:” recipients are excluded because they are not delivered to the recipients; however, they will be included in the message for handling at Trusted Courier 120.

The Private or Restricted message thus prepared, it is set aside for the moment so the ARM Record, previously constructed at step 1902, can be sent first. Step 1906 provides for the construction of an Access Restrictions Message using the same recipient lists as the Private or Restricted message being processed, and containing the corresponding ARM Record. It is via this separate message that the ARM Record is conveyed to the recipients of the Private or Restricted message. This technique enables the independent transport of message and ARM Record through Trusted Courier 120, and is therefore the critical element in ensuring end-to-end message privacy despite the intentional man-in-the-middle (Trusted Courier 120) required to simplify the user's experience. This technique also enables separate storage of message and ARM Record at the recipients' Agents 110, and is therefore the critical element in effecting the Message Recall capability to be described later.

In step 1907, the Access Restrictions Message so composed is formed into the body of a standard Internet email message addressed to Trusted Courier 120. This body is then signed and encrypted according to the S/MIME email encryption standard (IETF document RFC 1847) for complete protection during transport to Trusted Courier 120. In accordance with this standard, the message body is signed using the sender's private key (that is, the decryption/signing key in this case), a symmetric encryption key is chosen (in this case, a different key than the Content Key used to encrypt the Private or Restricted message content), the message is encrypted with that key, and that key is encrypted using the recipient's public key (in this case Trusted Courier 120's encryption/signature-validation key). Agent 110's Background Mail Client 217 then sends the Access Restrictions Message to Trusted Courier 120.

In step 1908 the Access Restrictions Message is shown being transported to Trusted Courier 120; this requires wrapping it in a message envelope noting the Trusted Courier's messaging address as the recipient rather than the true recipients' addresses. The address used for Trusted Courier 120 in this step is the one provided to Agent 110 during Registration as described above at step 508. Note that in an embodiment, this address will not only cause the message to reach Trusted Courier 120, it will also identify the sending Agent 110, thereby simplifying the handling of the message inside Trusted Courier 120; as is well known to those skilled in the art, routing messages based on their source is not well-supported in the standard mail-routing software, such as “sendmail,” that would form a core element of Trusted Courier 120's implementation.

Upon arrival of the message at Trusted Courier 120, at step 1909 the sender's address is used to retrieve an account entry from User Database 322. The decryption/signing key used by Trusted Courier 120 for messages from the sender is used to decrypt the S/MIME transport encryption key. This key is in turn used to decrypt the transport package and recover the S/MIME signature, along with the distribution headers and ARM Record. In step 1910, Trusted Courier 120 uses the sender's Agent's encryption/signature-validation key to authenticate the S/MIME signature, and if this authentication fails the message is discarded. While a log entry may note the event, no message is sent to any address associated with the message in order to avoid creating an avalanche. Assuming the signature validates correctly, the message headers can now be examined. Since the corresponding end-to-end encrypted message content is not yet available in Trusted Courier 120, the ARM Record cannot be used to examine the user's message at this time. Because there is no reason to do so at any time, and because to do so for all messages and all users would require enormous capacity in Information Storage module 303, Trusted Courier 120 does not retain a copy of the ARM Record after completing this step and the steps which follow.

Now Trusted Courier 120 steps through the list of recipients' addresses in the header, determining which refer to registered users and which are unregistered by searching for each address in User Database 322. The following processing steps occur for each recipient addressed in either the To: list, the CC: list, and the Bcc: list.

If at step 1911 the recipient is determined not to have an account in Trusted Courier 120, then at step 1912 a new database entry is allocated for this prospective new user and a copy of the Access Restrictions Message is stored there so it can be relayed later after Registration is complete. Then at step 1913 Trusted Courier 120 initiates the Invitation to Register process described above in the context of FIG. 4, giving it the messaging address to which the invitation should be sent. Steps 1914 and 1915 depict, in abbreviated form, the Invitation and Registration processes which will follow. Once Registration is complete, at step 1916 Trusted Courier 120 will notice that the previously unregistered address is now registered. It will then, at step 1917, release the stored message copy for that address and proceed as for a previously registered recipient.

This concludes the processing for an unregistered recipient's address. Again, as noted above, each of the preceding steps is executed for each unregistered recipient in the Access Request Message's header. Note that processing of the subsequent recipient addresses is not delayed awaiting a completed Registration from an unregistered recipient. Rather, upon launching the Invitation at steps 1913 and 1914, Trusted Courier proceeds to process the next recipient. Completion of the Registration in steps 1915 and 1916, and resumption of processing for a previously-unregistered recipient in step 1917, will occur asynchronously, and generally after the remainder of the recipients have been processed. It is possible that after some time entries in User Database 322 will exist that represent Invited users who chose never to complete Registration. Therefore, an implementation should, as part of good server hygiene practice well known to those skilled in the art, purge outstanding messages stored while awaiting registration by an unregistered user after a certain period not specified in the present invention. Whenever such a purge occurs, a non-delivery notice message should be sent to the original sender of each purged message.

At step 1918, then, Trusted Courier 120 determines that the recipient is a registered user of Private Messaging System 100, successfully retrieving the recipient's account data from User Database 322. Whether this follows a resumption of processing on a previously unregistered address, or constitutes the first action taken on this recipient for this message, is no longer pertinent at this point.

Now the message can be prepared for relaying to the recipient. At step 1919, the original end-to-end Access Restrictions Message, which consists of the original header with the Bcc: list removed and the ARM Record, is signed with the decryption/signing key Trusted Courier 120 uses for communication with the recipient's Agent 110. The S/MIME transport encryption using the recipient's encryption/signature-validation key is also applied. Ready to be relayed, the package is transported in a message from Trusted Courier 120 to the recipient's Agent 110 at step 1920, using Background Mail Server 314.

Upon the message's arrival at the receiving Background Mail Client 217, Agent 110 recovers the original package by reversing the S/MIME transport encryption. That is, using its decryption/signing key the receiving Agent 110 decrypts the S/MIME transport key and in turn uses the transport key to decrypt the message. Agent 110 also validates Trusted Courier 120's signature using its encryption/signature-validation key. Now the ARM Record is available, and in step 1921 Agent 110 stores it in Restriction Storage module 215, not having an entry matching the ARM Record's Message ID already.

This concludes the processing for a registered recipient's address. Again, as noted above, the preceding steps are executed for each recipient in the message header.

Returning now to the sending Agent 110, processing of the Private or Restricted message prepared and set aside at step 1905 may resume.

In step 1922, the end-to-end message, which includes header, encrypted content, and signature over those items, along with the list of “Bcc:” recipients if there are any, are composed into the body of a message addressed to Trusted Courier 120. This body is then signed and encrypted according to the S/MIME email encryption standard (IETF document RFC 1847) for complete protection during transport to Trusted Courier 120. In accordance with this standard, the message body is signed using the sender's private key (that is, the decryption/signing key in this case), a symmetric encryption key is chosen (in this case, a different key than was used to encrypt the actual message body), the message is encrypted with that key, and that key is encrypted using the recipient's public key (in this case Trusted Courier 120's encryption/signature-validation key).

Note that after all these rounds of encrypting, not only is the original message body protected, but so is the original message header. This is a significant improvement over the prior art. Also note that, with multiple signatures imbedded in the message at this point, the message can be authenticated both to Trusted Courier 120, and to the receiving Agent 110. In fact, the sender's signature over both encrypted body and header, delivered intact to the recipients, can be revalidated at a later date by Trusted Courier 120 if necessary, thus effecting an electronic notary service.

In step 1923 the message is sent to Trusted Courier 120; this requires wrapping it in a message envelope noting the Trusted Courier's messaging address as the recipient rather than the true recipients' addresses.

Upon arrival of the message at Trusted Courier 120, at step 1924 the sender's address is used to retrieve an account entry from User Database 322. The decryption/signing key used by Trusted Courier 120 for messages from the sender is used to decrypt the S/MIME transport encryption key. This key is in turn used to decrypt the transport package and recover the signatures, headers, and end-to-end encrypted message content. In step 1925, Trusted Courier 120 uses the senders Agent's encryption/signature-validation key to authenticate the two signatures in the message, and if either of them fails the message is discarded. While a log entry may note the event, no message is sent to any address associated with the message in order to avoid creating an avalanche.

Assuming the signatures validate correctly, the message headers can now be examined. If the header includes a request from the sender for a Courier Receipt, Trusted Courier 120 at this point, step 1926, constructs, encrypts, and signs a message to the sender acknowledging receipt of the message. In a preferred embodiment, this message is sent to the user's messaging address and presented as an ordinary Private message, thereby making the user responsible for any correlation that might be desired. In an alternate embodiment, the Courier Receipt may be sent to the Background Mail Client 217 at Agent 110 via Background Mail Server 314, thereby giving Agent 110 the responsibility to record, correlate, and present to its user the status of any requested receipts.

Now Trusted Courier 120 steps through the list of recipients' addresses in the header. The next several steps occur for each addressee. Note that Agent 110 sent an Access Request Message prior to sending the Private or Restricted message currently being processed. Proper queuing discipline, well known to those skilled in the art and exercised in implementing Trusted Courier 120, will have ensured that the Access Request Message was processed previously. Therefore, every recipient addressed in the Private or Restricted message will have an entry in User Database 322, and an account will be retrieved successfully at step 1927 in every case.

Since the Registration process noted in step 1915 is handled asynchronously, it is possible that the Private or Restricted message may arrive at Trusted Courier 120 prior to its completion. Therefore, it is necessary at step 1928 to examine the account record retrieved in step 1927 and ascertain whether Registration is in progress for this recipient. If this is in fact the case, the Private or Restricted message is added to the database record alongside the waiting Access Restrictions Message, to be processed later after Registration is complete. The remainder of the description will presume that event, and the processing of the held message queue for the newly Registered recipient will behave in the same manner as if the messages had just arrived.

Now the message can be prepared for relaying to the recipient. At step 1929, the original end-to-end package (header without Bcc: list, encrypted content, and sender's signature) is signed with the decryption/signing key Trusted Courier 120 uses for communication with the recipient's Agent 110, and the S/MIME transport encryption is applied for transport to the recipient user. Ready to be relayed, the package is wrapped in a message from Trusted Courier 120 to the recipient's Agent 110, and sent there at step 1930. Upon the message's arrival at the receiving Agent 110, in step 1931 Agent 110 recovers the original package by reversing the S/MIME transport encryption. That is, using its decryption/signing key the receiving Agent 110 decrypts the S/MIME transport key and in turn uses the transport key to decrypt the message. Agent 110 validates Trusted Courier 120's signature using its encryption/signature-validation key in step 1932, using the appropriate keys. Now the original header, the encrypted content, and the sender's signature are all available. Note that the sender's signature is not usable directly by the recipient, because only Trusted Courier 120 has the corresponding key. If validation is required at some point, a request to do so may be submitted to Trusted Courier 120. Also note that the “Bcc:” list is not present; this is in accordance with the normal processing of Bcc: addressees, which are not provided to recipients.

At step 1933, if the header indicates a request from the sender for a Delivery Receipt—that is, a notification message signifying the original message had arrived at the receiving Agent—the receiving user may be prompted by User Interface 211 to either accept the message or refuse delivery. This allows the recipient an opportunity to recognize the sender and reject the message (perhaps it's a collection notice, a subpoena, or an information package ordered C.O.D. but no longer wanted). Note that only messages with Delivery Receipt requested can be refused, because to prompt for refusal on every message is onerous, the next opportunity to act would be upon the message being read, and once a message is read it makes no sense to allow it to be refused. Therefore, a refusal opportunity for the recipient may only occur if the sender values the message highly enough to want a receipt.

In any case, if Delivery Receipt is requested, step 1933 is shown sending a receipt message, either delivery or refusal, to the sender through the Courier. Steps 1933a and 1933b indicate that the receipt message is processed exactly as any other message. In a preferred embodiment, this message is sent to the sending user's messaging address and presented as an ordinary Private message, thereby making the sender responsible for any correlation that might be desired. In an alternate embodiment, the receipt may be delivered to the sender's Background Mail Client 217 via Trusted Courier 120's Background Mail Server 314, thereby giving the sender's Agent 110 the responsibility to record, correlate, and present to its user the status of any requested receipts.

To proceed with processing the message, the Content Key is required. This information was previously received in the form of an ARM Record, and recorded in Restriction Storage module 215. Therefore, at step 1934 the ARM Record with Message ID field matching that of the received Private or Restricted message is retrieved.

In step 1935, if the recipient actually did refuse to accept the message, access to the message will be prevented by removing the Content Key from the ARM Record just retrieved. An alternate value will be stored there in its place, such as the string “Message Refused.” Without the original Content Key, the message content cannot be decrypted and therefore can never be viewed, thus providing a guarantee that the refused message was in fact never effectively received. Note that destruction of the message itself can only occur if Interfaces 231 and 232 within Agent 110 provide sufficient functionality to do so. Processing on the message ceases at this point in this situation.

Before the message can be presented, the recipient Agent 110 enforces any expiration date set by the sender. At step 1936, the ARM Record's expiration date field is checked, and if that date has passed the Content Key is removed. An alternate value will be stored there in its place, such as the string “Message Expired.” Without the original Content Key, the message content cannot be decrypted and therefore can never be viewed again, thus providing a guarantee that the message is effectively expired. Note that destruction of the message itself can only occur if Interfaces 231 and 232 within Agent 110 provide sufficient functionality to do so.

Assuming the message either was not refused or not given an opportunity to be refused, and further assuming the message has not expired, the receiving Agent 110 will proceed to decrypt the message content using the Content Key at step 1937, and present it to the user at step 1938. Note that the form of presentation will differ depending upon whether the message is Private or Restricted. A Private message may, if Interface 231 is sufficiently capable, appear in User Interface 221 of Messaging Client 112 as an ordinary message in the user's accustomed environment. For embodiments with less-capable Interface 231 implementations, User Interface 211 of Information Security module 111 will have to present the message content itself. A Restricted message will, regardless of Interface 231, always be presented by a dedicated function of Content Processing module 216; this ensures the restrictions on extracting or redistributing the message content are enforced. Also in step 1938, if the header indicates the sender requested a Presentation Receipt, which is similar in concept to the Read Receipt in prior art email systems, Agent 110 will construct, encrypt, and send a message acknowledging presentation of the message. This receipt is in turn processed as any other message in steps 1938a and 1938b. As for the other receipts described previously, a preferred and alternate embodiment are possible, distinguished by whether the background or foreground messaging resources are used to deliver it, and by which components of Agent 110 present it to the user.

This concludes the processing for a recipient. Again, as noted above, the preceding steps are executed for each recipient in the message header. After all recipients have been processed as described, the message transfer sequence is complete.

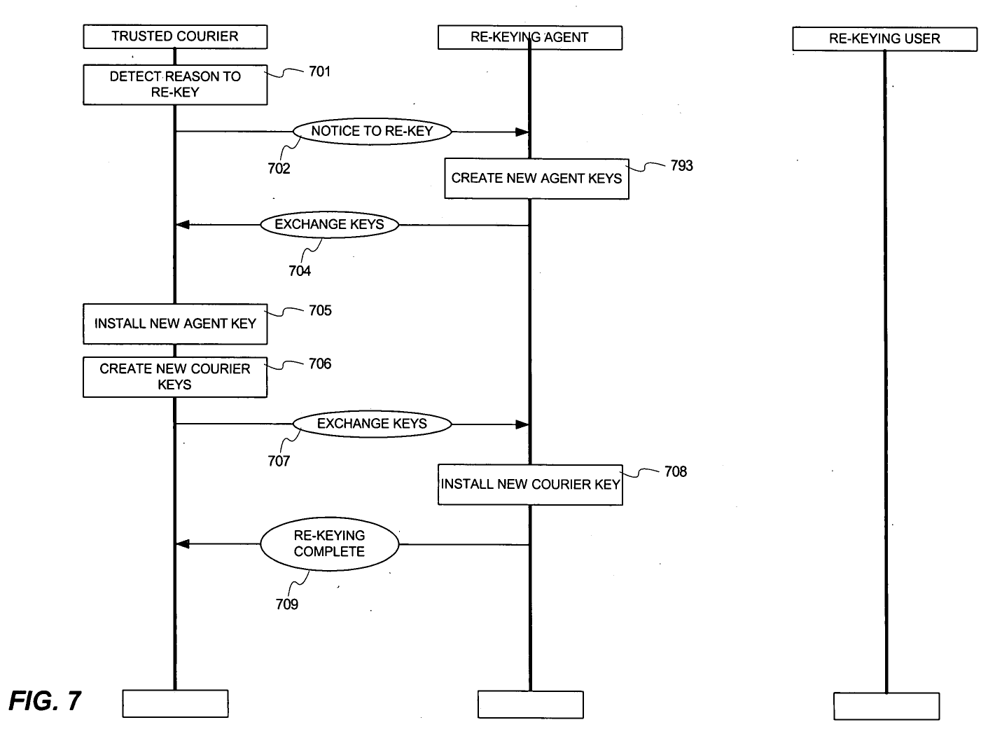

FIG. 7 depicts the process of replacing cryptographic keys. This may be used on a regular basis to guard against compromise of keys through external observation of traffic and corresponding cryptanalysis. It may also be used on an urgent basis in the event a key compromise is actually detected, although the present invention does not specify how such detection might occur. It is reasonable to assume, due to the other precautions taken during Registration and in the implementation of Agent 110, that as long as hygienic key replacement is done at a higher frequency than the expected cryptanalysis time for the keys being used, in general the replacement of keys will occur when the existing keys have not been compromised, and it is completely safe simply to exchange new keys without user intervention. For this reason, the Key Replacement process is identical to the key exchange steps that take place as part of Registration, except that the messages are transported using the Background Mail facilities rather than the Background Web facilities within each of Trusted Courier 120 and Agent 110. This allows the process to occur in the user's normal network contact pattern for messaging.

Key Replacement begins at step 701 with a trigger in Trusted Courier 120. The trigger could be detection of compromised keys, or expiration of a timer, or reaching a predetermined number of relayed messages for the account, or even a manual request from the user via Website 321. Whatever the trigger, in step 702 Trusted Courier 120 sends a Notice to Rekey message to Agent 110, encrypted and signed as usual, via Background Mail Server 314 and Background Mail Client 217. Agent 110 recognizes this as an internal message and processes it without user intervention, although if either of Interface 231 or Interface 232 offers a mechanism to do so a record of the event may be made in Message Storage module 222. At step 703, Agent 110 creates a new key pair for itself, in the same manner as it did during Registration at step 515. Agent 110 will then send to Trusted Courier 120 in step 704 its new encryption/signature-validation key using Background Mail Client 217.

Upon receiving the Agent's key, Trusted Courier 120 will store it in step 705, create its own new key pair and sign the Agent's key in step 706, and send its encryption/signature-validation key and the now-certified Agent key back to Agent 110 in step 707, again through Background Mail Server 314 and Background Mail Client 217. Agent 110 stores Trusted Courier 120's new key in step 708. To conclude the rekeying process, Agent 110 informs Trusted Courier 120 that rekeying is complete by sending it a message, encrypted and signed using the keys just exchanged, via Background Mail Client 217. Step 709 depicts this message as “Rekeying Complete.”

Note that the process as described here allows the computer or device within which Agent 110 is running to be only intermittently connected to, or “on-line” with, Packet Network 102, just as normal messaging may be accomplished with intermittent connection to Messaging Infrastructure 101. Thus, the key exchange may occur somewhat later than the time of receiving the Notice to Rekey message. Therefore, great care is taken in both Agent 110 and Trusted Courier 120 to avoid discarding old keys before all messages which use them have been delivered.

Alternatively, the key exchanges described may be accomplished using a secure tunnel wherein agent 110 is actively connected to or online with packet network 102 at the time of the key exchange. This offers the advantage of using the key exchange approach used during registration.

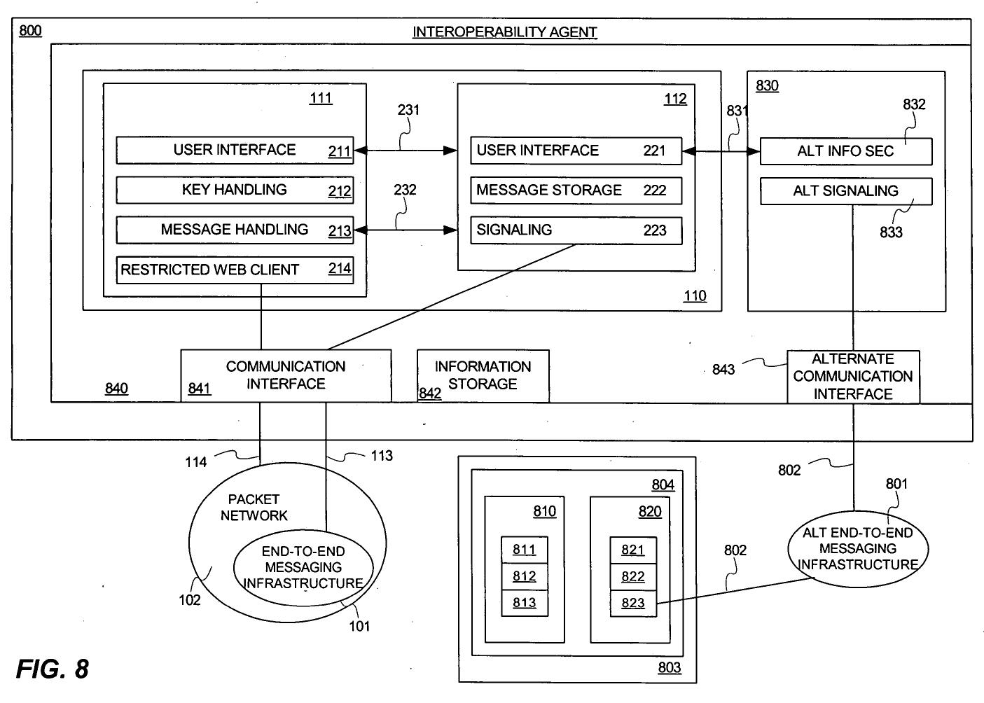

Turning now to FIG. 8, we find another embodiment of the Agent from FIG. 2. This embodiment is designed for extending the Private Messaging services to wireless devices such as cellular phones, which may be programmable to run enhanced software applications but generally have less computing capability than larger and more-expensive personal computers and PDAs.

Their lesser capability makes it difficult for such devices to process the cryptographic protocols described previously. The messaging service available to them may also be of lesser capability; for example, the wireless Short Message Service (SMS) in most cellular networks only delivers 140-160 characters at a time. Therefore, to allow the users of such devices to participate in the Private Messaging system, an Interoperability Agent 800 is defined, which acts as an adaptor between the cryptographic and messaging protocols of the email-based preferred embodiment previously described, and the limited protocols achievable by wireless devices.

First, the devices supported by Interoperability Agent 800 are characterized. FIG. 8 shows a Thin Agent 804 running in an Alternate Computing Device 803. These represent, for example, the cellular phones discussed above, but might be any device of lesser capability than is necessary for running a complete Agent 110. Even an older (slower) computer would fit this description. Thin Agent 804 comprises elements that correspond to those of Agent 110.

An Alternate Information Security module 810 provides the scaled-down encryption and signature functions achievable in Alternate Computing Device 803, with Alternate User Interface 811, Alternate Key Handling module 812, and Alternate Message Handling module 813 covering the corresponding functionality of modules 211, 212, and 213 respectively. Note that Alternate Information Security module 810 may not include a module corresponding to Restricted Web Client 214. This is because the typical Thin Agent 804 would not be able to process any encryption at all, so Alternate Key Handling module 812 will often be a null function anyway, implying no need for secure key exchange.

For those Thin Agents 803 that can process rudimentary encryption, key exchange will generally occur via a pre-arranged shared secret. Similarly, Alternate Messaging Client 820 and its components Alternate User Interface 821, Alternate Message Storage (822), and Alternate Signaling (823) are intended to comprise a standard messaging function, analogous to Agent 110's Messaging Client 112 and its components 221, 222, and 223, but compatible with the less-capable Alternate End-to-End Messaging Infrastructure 801. For example, Alternate Infrastructure 801 might be implemented as wireless SMS, so Alternate Messaging Client might be a set of text-messaging commands in a cellular phone.

Interoperability Agent 800, then, fits into the Private Messaging System 100 as an Agent 110. As shown in FIG. 8, an actual complete Agent 110 with exactly the same elements and interfaces as previously described comprises a significant portion of Interoperability Agent 800. However, the specific Messaging Client 112 here is chosen to be more usable in a server environment, in contrast to the typical specific Messaging Client 112, which would be oriented more to end users' needs. In particular, User Interface 221 would in this case have a textual mode that is easily connected to Adaptor 830 via interface 831, while the typical User Interface 221 would primarily operate in a graphical mode.

Since Agent 110 cannot interact properly with Thin Agent 804, it operates alongside Private Messaging Adaptor 830. Adaptor 830 provides the interworking function between the two encryption and messaging domains. It acts both as a user of Private Messaging System 100, through Alternate InfoSec module 832 (which provides either a lightweight encryption or none at all) and its interactions with Agent 110's User Interface 221 on interface 831, and in turn as a messaging entity on Alternate End-to-End Messaging Infrastructure 801, through Alternate Signaling module 833. A model, and perhaps even an implementation of these relationships and behaviors can be found in the various Short Messaging Entities (SMEs) that provide interoperability between wireless SMS and other messaging services.

Interoperability Agent 800 acts as a server, standing alone in the network between two domains. To accomplish this, Agent 800 is supported by its own Programmable Computing Platform 840, which provides the usual processing and memory capabilities, including Information Storage module 842. Platform 840 may also include Communication Interface 841, through which Interfaces 113 and 114 of Private Messaging System 100 flow, and Alternate Communication Interface 843, through which flows Interface 802 for interacting with Alternate Infrastructure 801.

Though it is not explicitly depicted in FIG. 8, Interoperability Agent 800 may implement multiple pairs of Agent 110 and Adaptor 830 in a single Platform 840, so that it may support multiple Thin Agents 804 simultaneously. No capacity limitation should be inferred from this description; the full spectrum of possible implementations is implied.

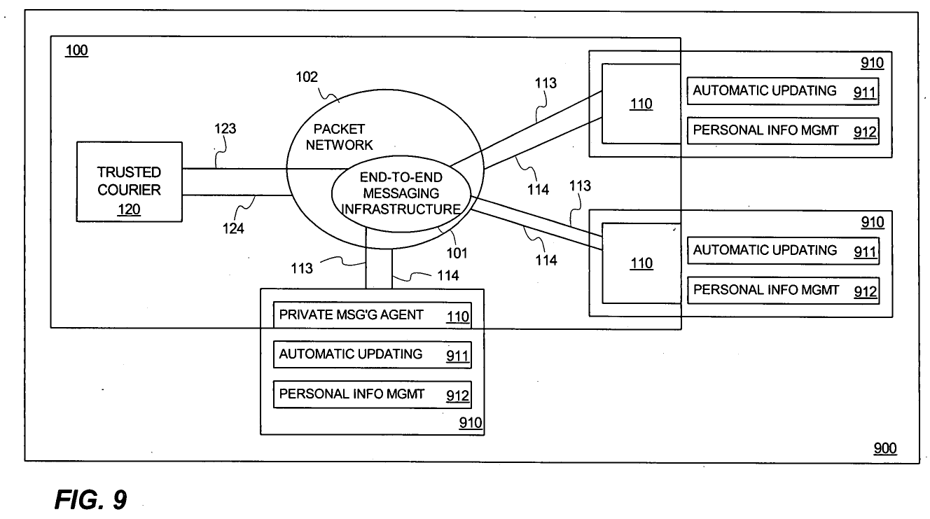

In FIG. 9 through FIG. 14 we describe the Automatic Personal Information Update capability that is built upon the Private Messaging System 100. FIG. 9 begins the description with an overall view of the system. Automatic Personal Information Updating System 900 provides the desired capability, as described in the Background and Summary sections above, to propagate automatically among numerous users the changes in personal information each user stores in a personal information management application or device. Examples of such devices include personal computers, personal digital assistants, wireless telephones, and any of the various combination devices that provide more than one of these functions.

Completely encapsulated within Updating System 900 is Private Messaging System 100. By using Private Messaging, the users of System 900 can trust one another's communications: The sender and recipients of the messages are authenticated, and information update messages may be encrypted to protect its content from interception and tampering. Thus, Trusted Courier 120 and Private Messaging Agents 110 are inherently components of Updating System 900, and connectivity is provided by End-to-End Messaging Infrastructure 101 and Packet Network 102, as previously described.

The Agent model from System 100 is extended in System 900 to include the Personal Information Updating capability acting on a user's behalf. This is the heart of the system encapsulation: Each Agent 910 comprises both the new functionality and a complete Private Messaging Agent 110. Personal Information Management module 912 represents the user's personal information management application or device, which could be implemented in a contact list program, a PDA, or even an ordinary wireless telephone. Automatic Updating module 911 provides the enhanced functionality of this aspect of the present invention.

Existing instances of such programs may be enhanced by the capabilities of Automatic Updating module 911, or a new custom instance of Personal Information Management module 912 could be created when implementing the present invention. For example, the invention's features are added to an existing such application program or device.

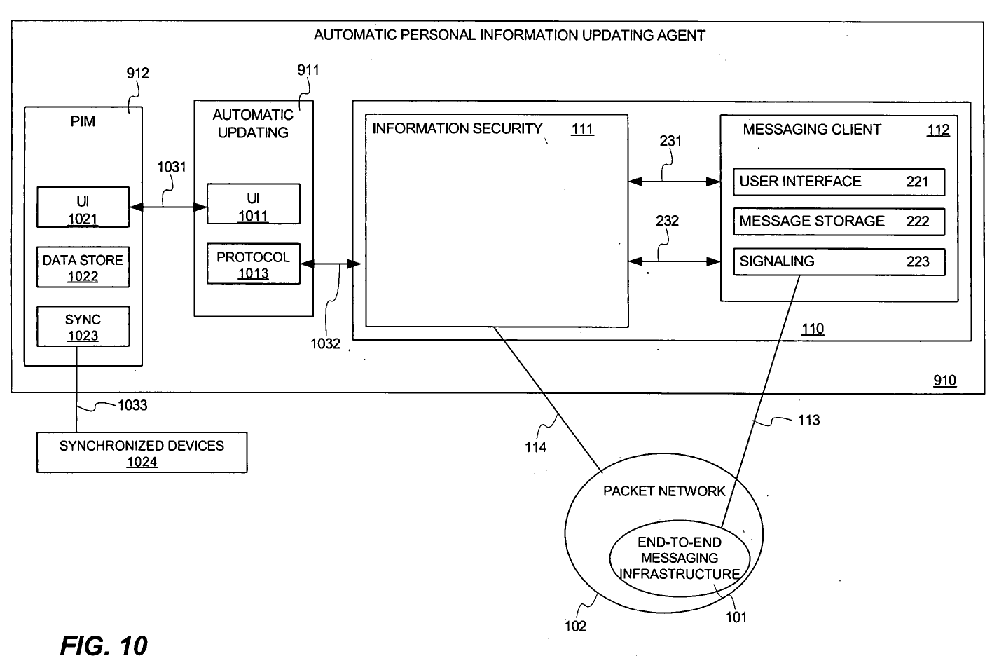

For more detail, we turn now to FIG. 10, which depicts a block diagram of Agent 910, noting once again that Agent 910 encapsulates a Private Messaging Agent 110. Its components are there as shown previously in FIG. 2. In addition, it can be seen here that Message Handling module 213 provides an Application Interface 1032, whereby modules that implement services such as this one may exchange private messages with one another.

Application Interface 1032 offers only the ability to send and receive private messages. By providing no ability to manipulate directly the encryption and signature functions in Key Handling module 212, the integrity of both the Private Messaging capability and the Automatic Updating capability's use of it is protected.

Personal Information Management module 912 is the user's personal information management application program, or the core functionality of the user's personal information management device. Its components may include a User Interface 1021, whereby the user interacts with the program or device to store, retrieve, and modify personal information; a Data Storage module 1022, wherein the personal information is actually kept; and a Synchronization module 1023, which replicates the entire personal information content of module 912 in one or more Synchronized Devices 1024 via synchronization interface 1033.

Note that synchronization is different from the Automatic Updating capability of the present invention. Synchronization replicates the entire content, every entry, of one personal information management application program or device in another, and ensures that changes in either are reflected in the other. Generally a single user owns all of these multiple replicas. In a typical synchronization example, a single user has both a personal computer (PC) and a personal digital assistant (PDA), and keeps a contact list in each. Synchronization functions ensure that the contact list is identical in each device.

Automatic Updating, on the other hand, is used by multiple users with independent databases. To the extent that a user's database includes a subset of entries whose content is known because it was shared by another, Automatic Updating allows each sharer to retain control over the shared information as it is reflected in the user's database. In a sense, Automatic Updating is similar to the publish/subscribe information sharing paradigm that is known in the art. In the present invention the “publish” part of that paradigm may be the only part used. A user can choose to inform others of updates (publish), and accept updates from others, but not demand to be informed of updates by others (subscriber).

User Interface module 1011 enhances User Interface 1021, via Application Interface 1031, to allow for user control and data flow, and Protocol module 1013 uses Application Interface 1032 to drive the message exchanges, through Private Messaging Agent 110, that propagate and accept changes. The user interface enhancements provide for identifying which personal information to share with which correspondents, as well as from which correspondents updates should be accepted automatically. Protocol module 1013 takes care of structuring changed personal information into a formatted update message, and sending it out as requested. It also parses received update messages to extract the changed information, and makes the changes in Personal Information Management module 912 as appropriate.

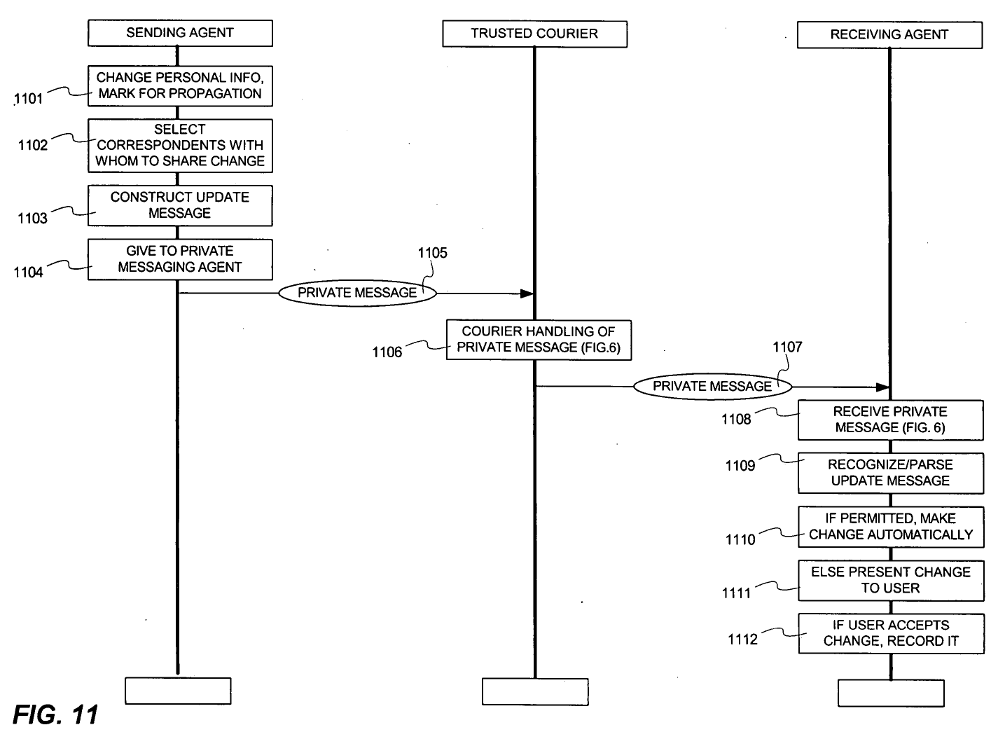

FIG. 11 depicts the process and information flow used to implement the Automatic Updating capability. Here the behavior of Protocol module 1013 will become clear. The process begins at step 1101 with the user who controls a piece of personal information, perhaps the user's own address, making a change to that personal information and choosing to propagate that change to one or more other users. Next, at step 1102 the user selects which correspondents should receive the updated information; in an embodiment these are selected from among the entries in the user's contact list as stored in Personal Information Management module 912. These first two actions are facilitated by the User Interface modules 1021 and 1011 in cooperation with one another as described above.

Protocol module 1013 takes over in step 1103, constructing the Update Message which will propagate the changed information to the correspondents selected in step 1102. The format of this Update Message is not essential to the invention, and so is not specified. Any format which conveys the change will do. In an embodiment, a format based on the vCard standard (Internet Engineering Task Force document RFC2426) is used, with the change reflected as the difference between two complete vCard data structures carried in the Update Message: one for the old values prior to the change, and one for the new values after the change. At step 1104, the prepared Update Message is given to Private Messaging Agent 110 for secure transmission. The process shown in FIG. 6 is followed, taking the message to Trusted Courier 120 in step 1105, through Courier 120 in step 1106, to the designated correspondent or correspondents in step 1107, and into the receiving Private Messaging Agent 110 for validation instep 1108.

Upon receipt, in step 1109 the Update Message is recognized as being part of the Automatic Updating service, so Protocol module 1013 at the recipient's Agent 910 takes over and parses the message. In extracting the changed information, the parsing process also validates that the message was constructed correctly; Private Messaging Agent 110 will have already ensured the sender's identity is correct before passing the message along. Once the information to update is determined, User Interface module 1011 checks whether it is permitted automatically to make changes received from the sender of this update. Such permission will have been established by the user based upon previous experience with updates from this sender. At step 1111, if automatic permission was not granted, the details of the update are presented to the user by User Interface module 1011 and User Interface module 1021 acting in concert. The user is given the option at this point to accept the update or not, and a separate option to permit automatic action on updates from the sender of this one. At step 1112, if this update has been permitted User Interface module 1011 commands User Interface module 1021 to record it in Data Storage module 1022. An indication of whether permission has been granted for automatic action is also stored. Thus concludes the Automatic Personal Information Updating Process. Because it is built upon the Private Messaging System, the privacy and authenticity of updates is assured, allowing the updating process itself to be quite simple.

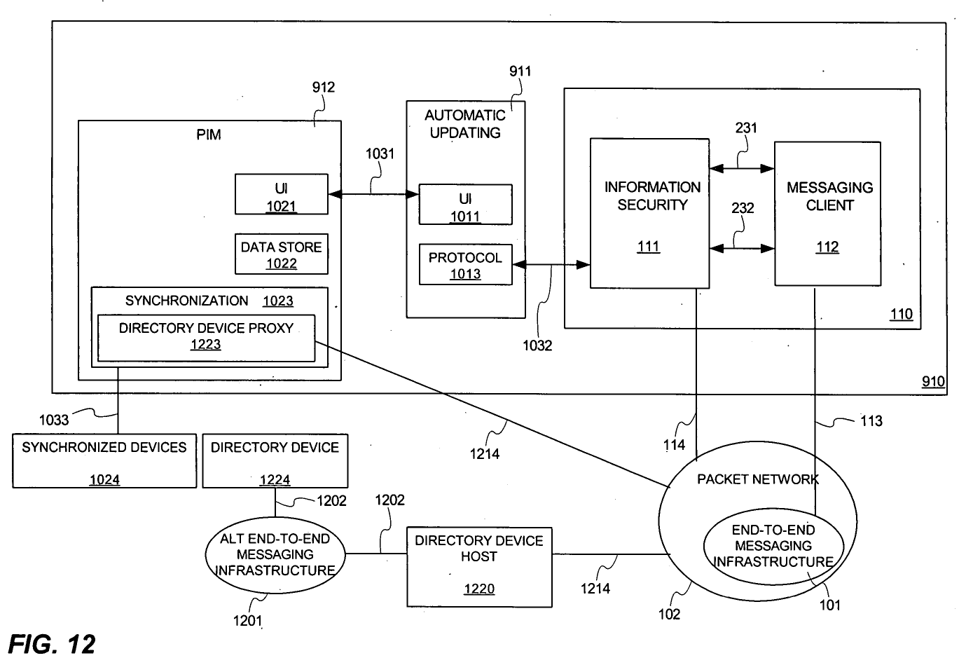

While the invention aspect of the foregoing descriptions is suitable for implementation in PCs, PDAs, and other computationally powerful devices, a large class of devices is excluded. For example, a typical cellular telephone generally contains a substantial directory of phone numbers called by its user. Such a device is unable to participate as an Agent 910 in System 900 because it hasn't sufficient processing power or programmability. Nevertheless, it would be desirable to allow this cache of personal information an opportunity for automatic updating. FIG. 12 depicts a mechanism for doing so. A Proxy Agent for Directory Devices is shown as an Agent 910 in which Synchronization module 1023 is enhanced by Directory Device Proxy 1223, a module that can propagate updates to a Directory Device 1224. For propagation to occur, Directory Device 1224 provides a separate mechanism to modify its directory contents. This separate mechanism is embodied in FIG. 12 as Directory Device Host 1220, a server which receives commands from Proxy 1223 via Interface 1214 and in turn commands Directory Device 1224 via Alternate End-to-End Messaging Infrastructure 1201. Note that only Proxy 1223 and its relationship with Agent 910 are novel in this arrangement; Host 1220, Infrastructure 1201, and Directory Device 1224 are assumed to be existing systems. For example, if Directory Device 1224 is a typical cellular telephone, one of its features will be a mechanism for changing configuration parameters that is often referred to as “Over-the-Air Programming” (OTAP). Some service providers offer a system, such as a website, whereby users may access the OTAP capability to download new directory entries to the phone from a computer file without having to enter them individually by hand. The website which provides this access would be Host 1220, and the OTAP protocols and wireless infrastructure would be Infrastructure 1201. However, it is also possible to consider a custom system providing this capability; both custom and existing arrangements are intended to be described by FIG. 12.

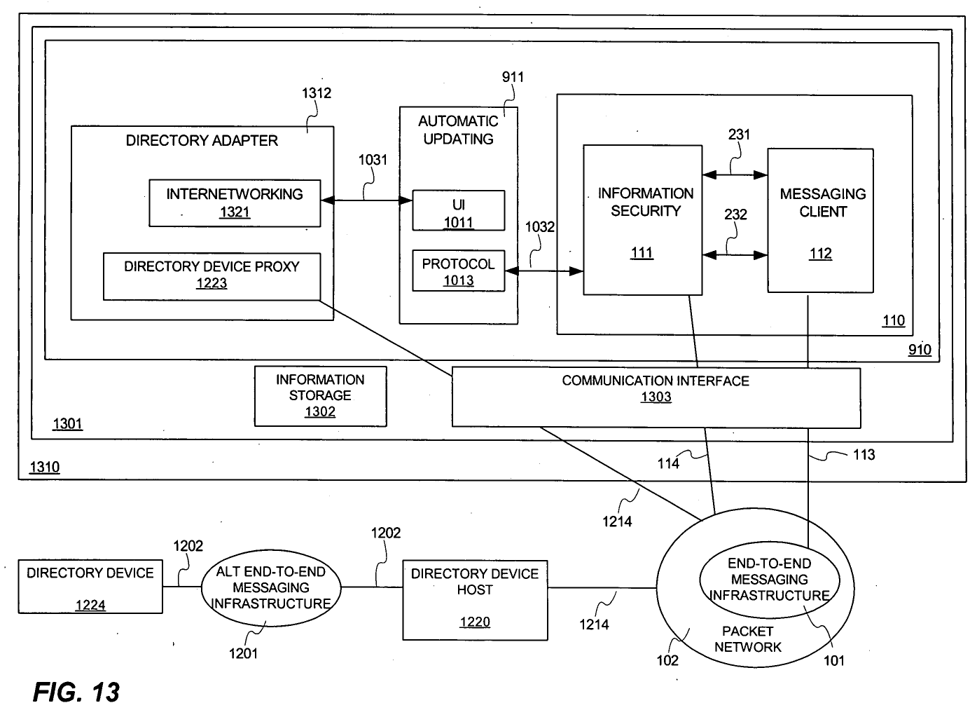

Now, the Proxy Agent in FIG. 12 is shown standing alone. In this respect it is intended that Proxy 1223 would be implemented as an enhancement to the typical PC-user's or PDA-user's Agent 910. In this case Directory Device 1224 would be owned or controlled by the same user who owns or controls Agent 910 and the PC or PDA in which it is run. However, in many cases a user of a Directory Device 1224 does not also use a PC or PDA that can host an Agent 910. To support these users, a Proxy Agent Server for Directory Devices is defined; its block diagram is shown in FIG. 13.

Proxy Agent Server 1310 comprises, as do the other servers described in this invention, a Programmable Computing Platform 1301 in which Agent 910 runs as a software application. Platform 1301 provides the usual components, including Information Storage module 1302 for persistent configuration data, and Communication Interface 1303 for network connectivity. The Agent 910 which runs in Proxy Agent Server 1310 has the same functionality as a PC-based or PDA-based Agent, including a complete Private Messaging Agent 110 and identical Automatic Updating module 911, except that Personal Information Management module 912 is replaced by a Directory Adaptor 1312. In place of a User Interface 1021 and Data Storage 1022, Adaptor 1312 provides only an Interworking module 1321, which interacts with Automatic Updating module 911 and its User Interface module 1011 to receive updates from other users. Upon receiving on update, Interworking module 1321 hands it to Directory Device Proxy 1223 for delivery to Directory Device 1224 via the same path as shown in FIG. 12.

Proxy Agent Server 1310 thus provides an Agent 910 that acts on behalf of Directory Device 1224's user, so the user is not required to own a PC or PDA with an Agent 910. Note that, although not explicitly depicted, Proxy Agent Server 1310 is intended to provide this service for a large number of users, and therefore it will actually include a similarly large number of Agents 910. Information Storage module 1302 is essential in this case, because it holds subscription information linking each Agent 910 to each Directory Device 1224. This also implies a subscription management functionality, again linked to Information Storage 1302, so that users can sign up for the service. Other components visible in FIG. 13 correspond exactly to their earlier descriptions.

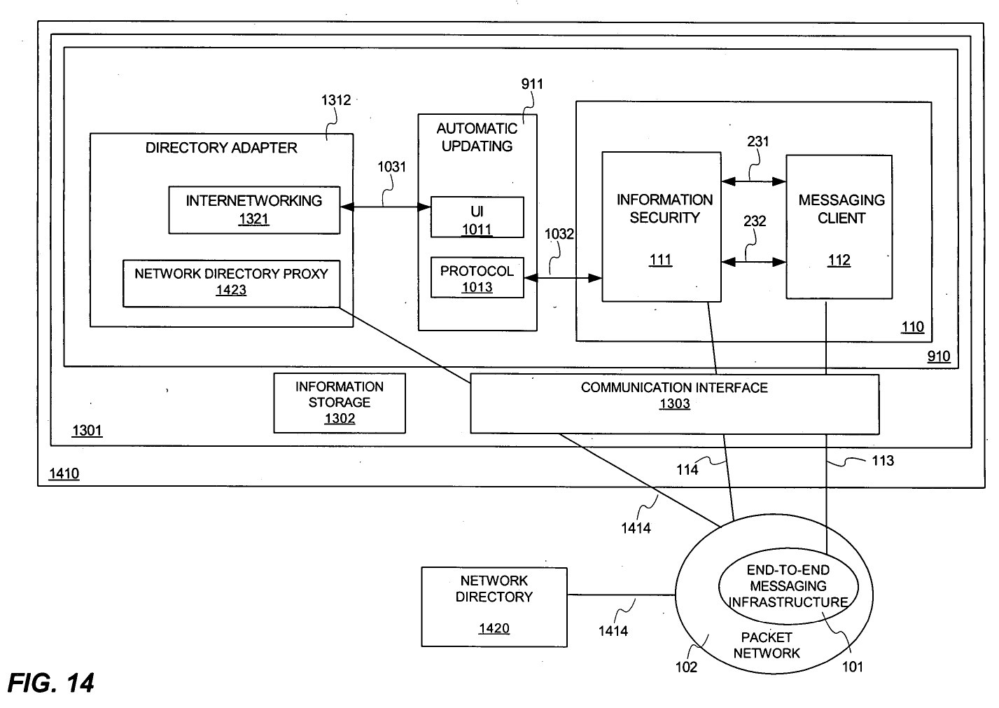

Yet another kind of personal information repository is the network directory, such as an LDAP server, in which are kept email addresses and other shared data regarding users of a system. Generally, the content of such directories is centrally controlled, and users have no direct mechanism to make changes. The Proxy Agent Server for Network Directories 1410 depicted in FIG. 14 provides a mechanism whereby users of Automatic Updating System 900, through their own Agents 910, may send updates to the network directory and have them automatically recorded there.

Proxy Agent Server for Network Directories 1410 is identical in form and function to Proxy Agent Server for Directory Devices 1310, except that its proxy module, Network Directory Proxy 1423, is designed to interact with Network Directory 1420. This interaction takes place via Interface 1414, which may be a path through Packet Network 102 as shown, or any other path including a private network or a direct link. The protocol for Interface 1414 may be a standard directory access protocol such as the Internet's Lightweight Directory Access Protocol (LDAP), a proprietary protocol such as would be implemented in Microsoft's Exchange product, or any other mechanism. Note that, while Servers 1410 and 1310 are described as all but identical, a preferred embodiment of System 900 in which both exist would implement them on different instances of Platform 1301, and they would not share any specific instances of Private Messaging Agent 110 or Automatic Updating module 911.

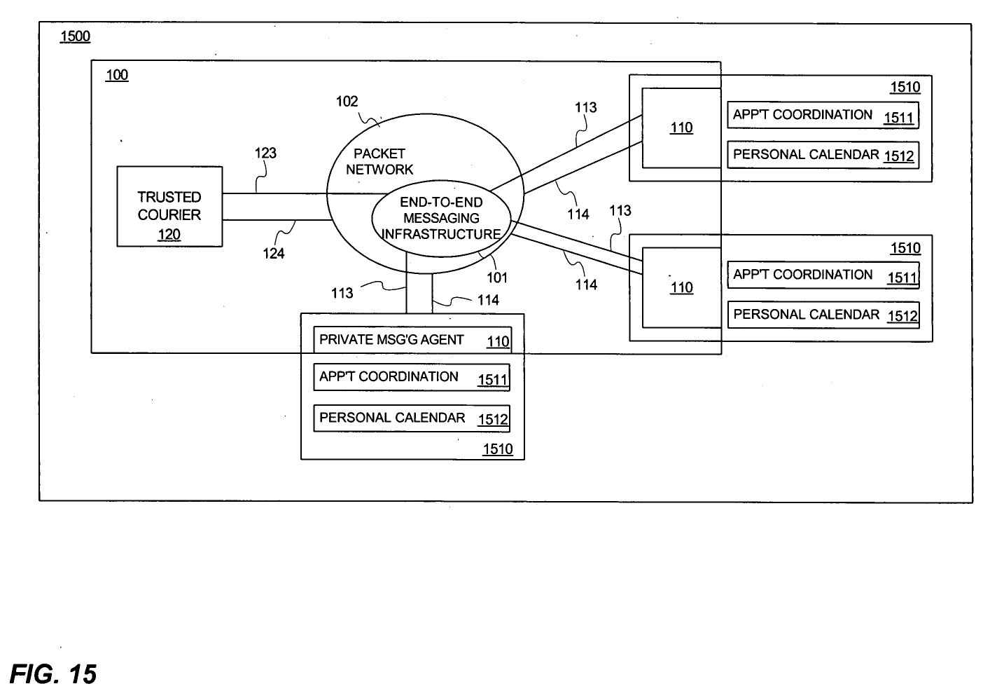

Thus concludes the description of Automatic Updating System 900 and the Automatic Updating capability. It should be clear at this point the ease with which additional services may be built upon the Private Messaging System 100, using the encapsulation and transport paradigms underlying the foregoing description. Therefore we will now describe one more, using FIGS. 15 through 18 to depict an Automatic Appointment Coordination capability.

Automatic Appointment Coordination System 1500, shown in FIG. 15, provides the desired capability, as described in the Background and Summary sections above, for multiple individuals' personal calendaring devices to share personal schedule information and automatically reach consensus on the date and time of a meeting proposed by one of them (hereinafter referred to as “the proposer”). Examples of such calendaring devices include personal computers, personal digital assistants, and wireless telephones with PDA functions included.

System 1500 is designed with a structure similar to that of System 900, in that it completely encapsulates Private Messaging System 100. By using Private Messaging, the users of System 900 can trust one another's communications: the sender and recipients of every message are authenticated, and every schedule information message is encrypted to protect its content from interception and tampering. Thus, Trusted Courier 120 and Private Messaging Agents 110 are inherently components of Appointment Coordination System 1500, and connectivity is provided by End-to-End Messaging Infrastructure 101 and Packet Network 102, all as previously described.

The Agent model from System 100 is extended in System 1500 to include the Appointment Coordination capability acting on a user's behalf. This is the heart of the system encapsulation: Each Agent 1510 comprises both the new functionality and a complete Private Messaging Agent 110. Personal Calendar module 1512 represents the user's personal schedule management application or device that could be implemented in, for example, a calendar program or a PDA. Appointment Coordination module 1511 provides the enhanced functionality of this aspect of the present invention. The invention contemplates the enhancement of such programs by the capabilities of Appointment Coordination module 1511; though Personal Calendar module 1512 that could be created when implementing the present invention. In one embodiment, the invention's features are added to an existing such application program or device.

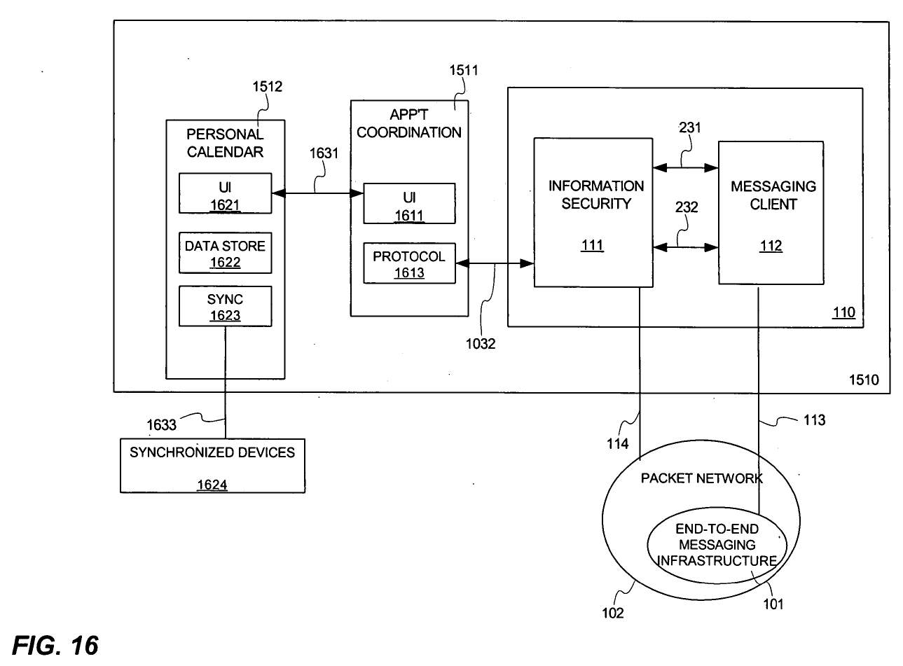

For more detail, we turn now to FIG. 16, which depicts a block diagram of Agent 1510, noting once again that Agent 1510 encapsulates a complete Private Messaging Agent 110. All its components are there as shown previously in FIG. 2. In addition, it can be seen here that Message Handling module 213 provides an Application Interface 1032, where modules that implement services such as this one may exchange private messages with one another. Application Interface 1032 offers the ability to send and receive private messages. By providing no ability to manipulate directly the encryption and signature functions in Key Handling module 212, the integrity of both the Private Messaging capability and the Appointment Coordination capability's to use it are protected.

Personal Calendar module 1512 is the users personal schedule management application program, or the core functionality of the user's personal schedule management device. Its components include a User Interface 1621, wherein the user interacts with the program or device to store, retrieve, and modify schedule information; a Data Storage module 1622, wherein the schedule information is actually kept; and a Synchronization module 1623, which replicates the entire personal schedule content of module 1512 in one or more Synchronized Devices 1624 via synchronization interface 1633.

Appointment Coordination module 1511 includes the features of this aspect of the invention. User Interface module 1611 enhances User Interface 1621, via Application Interface 1631, to allow for user control and data flow, and Protocol module 1613 uses Application Interface 1032 to drive message exchanges through Private Messaging Agent 110. The user interface enhancements provide for identifying appointments that require coordination, the correspondents who should be invited, and the results of the coordination process. They also allow the user to identify those correspondents with whom coordination activities may be processed automatically. Protocol module 1613 takes care of the interactions with Appointment Coordination modules 1511 in other Agents 1510, obtaining and providing schedule information, inviting their users to meetings, and accepting invitations on behalf of the local user.

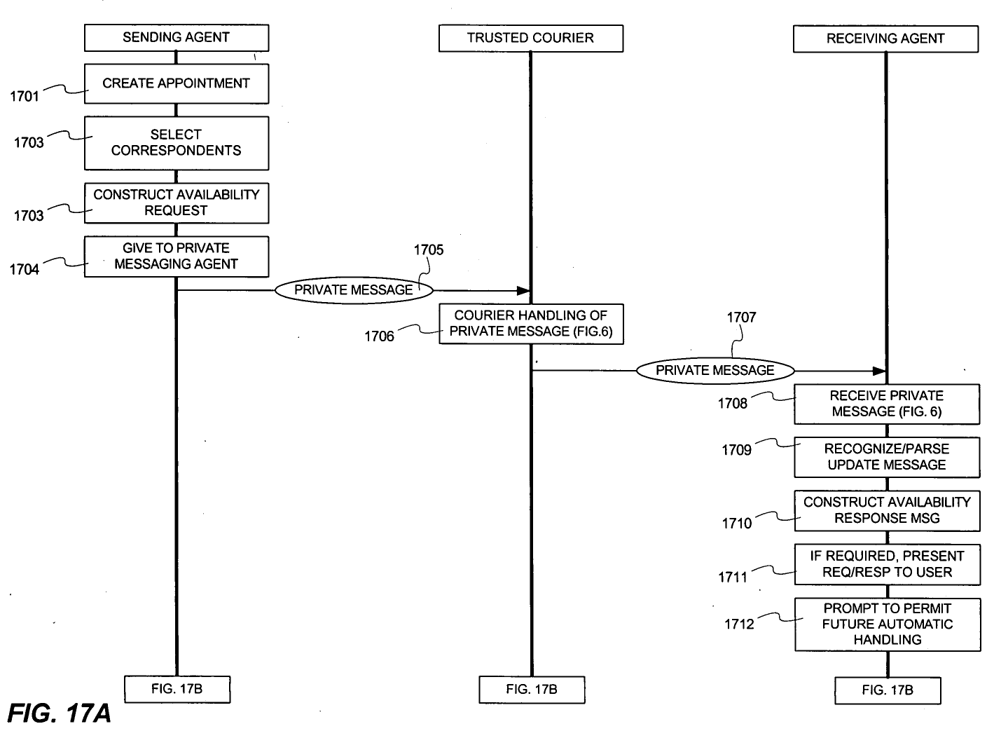

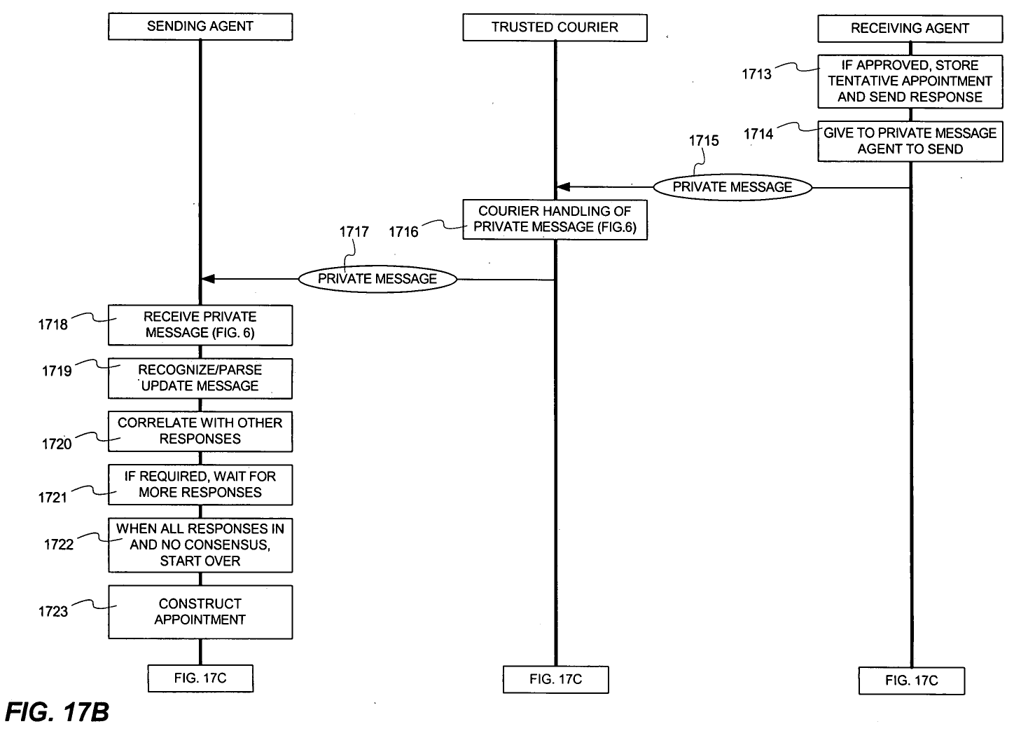

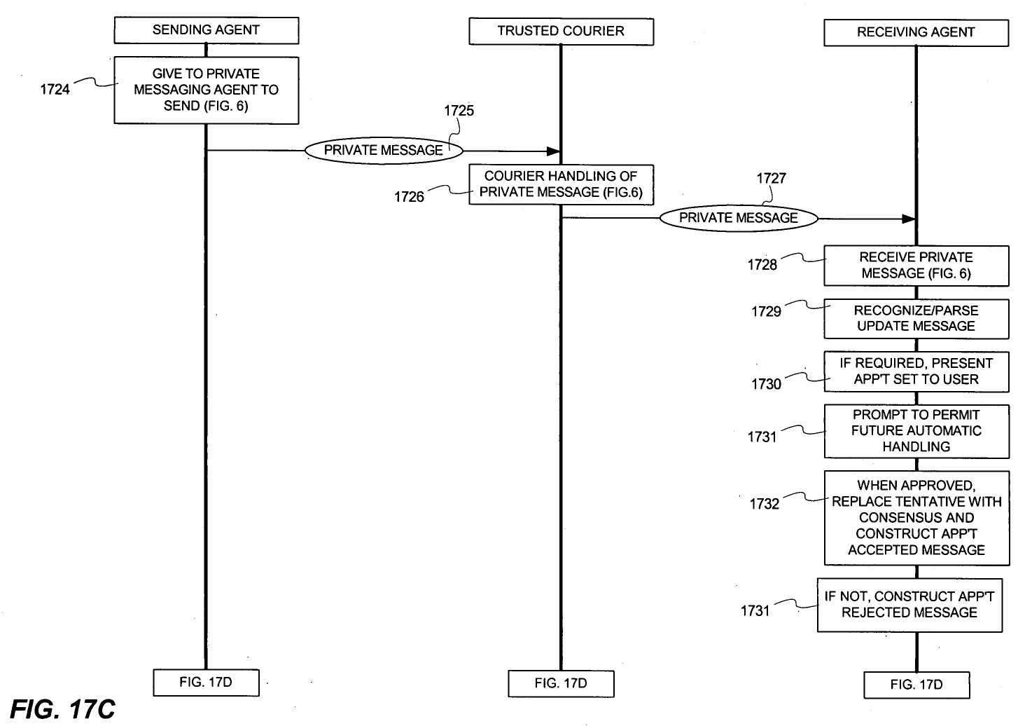

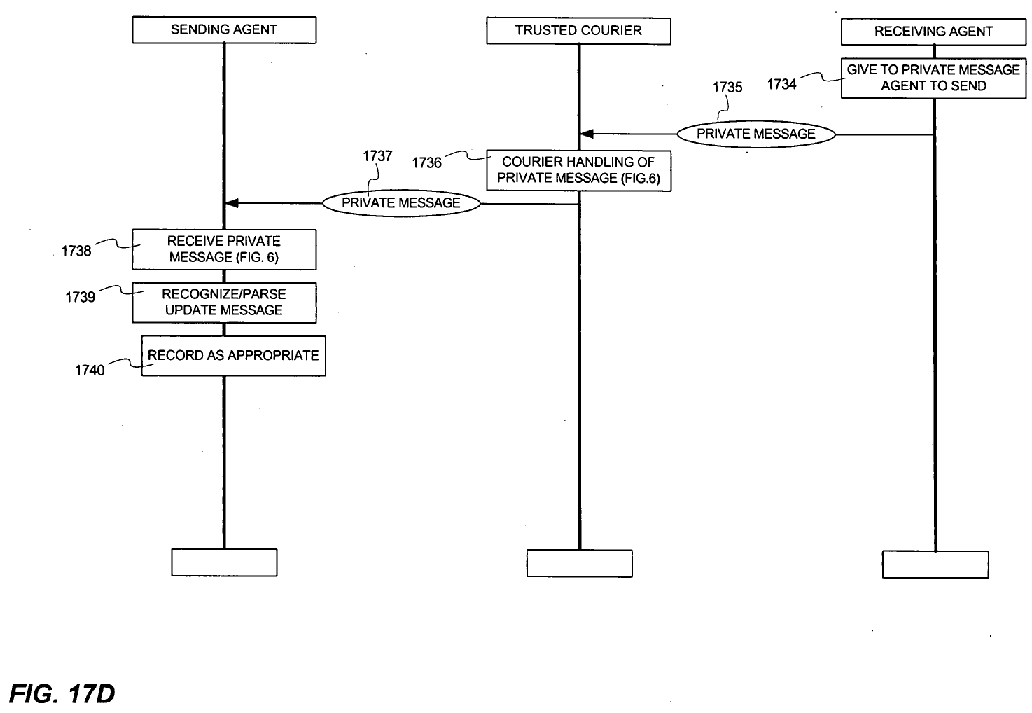

FIG. 17 depicts an embodiment of the process and information flow used to implement the Appointment Coordination capability. Here the behavior of Protocol module 1613 is described. The process begins at step 1701 with the user who wishes to schedule a meeting creating a tentative appointment in Personal Calendar module 1512, and choosing one or more time windows within which the appointment is proposed to occur. Next, at step 1702 the user selects which correspondents should be invited to the meeting, and therefore with whose Agents 1510 automatic coordination should be attempted.

Note that this selection process is facilitated when Personal Calendar module 1512 is accompanied by, or at least integrated loosely with, a Personal Information Management module 912: In an embodiment these may be selected from among the entries in the user's contact list as stored in Personal Information Management module 912. However, such integration is not required by the present invention; correspondents' messaging addresses may be entered explicitly at this point without the assistance of any database in an alternate embodiment. These two actions may be facilitated by the User Interface modules 1621 and 1611 in cooperation with one another as described above.

Protocol module 1613 takes over in step 1703, constructing an Availability Request Message that will propose the appointment to the correspondents selected in step 1702. Any format that conveys the proposed time windows can be used. In an embodiment, a format based on the iCalendar standard (Internet Engineering Task Force documents RFC2445 and RFC2446) is used, with the windows reflected as a series of event specifications using an enhanced starting time format that encodes a range of time. At step 1704, the prepared Appointment Request Message is given to Private Messaging Agent 110 for secure transmission. The process shown in FIG. 6 is followed, taking the message to Trusted Courier 120 in step 1705, through Courier 120 in step 1706, to the designated correspondent or correspondents in step 1707, and into the receiving Private Messaging Agent 110 for validation in step 1708.

Upon receipt, in step 1709 the Appointment Request Message is recognized as being part of the Appointment Coordination service, so Protocol module 1613 at the recipient's Agent 1510 takes over and parses the message. In extracting the appointment proposal, the parsing process also validates that the message was constructed correctly; Private Messaging Agent 110 will have already ensured the sender's identity is correct before passing the message along. Once the proposal is identified, at step 1710 Protocol module 1613 examines the schedule in Personal Calendar Module 1512, via the cooperating User Interface modules 1611 and 1621, to determine a response to the proposal, and constructs an appropriate Availability Response Message. User Interface module 1611 checks whether it is permitted to respond automatically to requests from the sender. Such permission will have been established by the user based upon previous experience with this sender.

At step 1711, if automatic permission was not granted, the details of the proposed appointment and the tentative response are presented to the user by User Interface module 1611 and User Interface module 1621 acting in concert. The user is given the option at step 1712 to accept the proposal or not, and a separate option to permit automatic action on proposals from the sender. At step 1713, if this proposal has been approved User Interface module 1611 commands User Interface module 1621 to record it in Data Storage module 1622. An indication of whether permission has been granted for automatic action is also stored.

At step 1714, the prepared Availability Response Message is given to Private Messaging Agent 110 for secure transmission back to the sender of the original Availability Request Message. Once again the process shown in FIG. 6 is followed, taking the message to Trusted Courier 120 in step 1715, through Courier 120 in step 1716, to the meeting proposer in step 1717, and into the proposer's Private Messaging Agent 110 for validation in step 1718.

Upon receipt, in step 1719 the Availability Response Message is recognized as being part of the Appointment Coordination service, so Protocol module 1613 at the proposer's Agent 1510 takes over and parses the message. If other Availability Response Messages for this proposal have already arrived, at step 1720 this one is correlated with those in search of a consensus on the details of the meeting. In step 1721, the proposer's Agent 1510 quiesces to await additional Availability Response Messages from other correspondents.

When Availability Response Messages have been received from all correspondents, step 1722 determines whether a sufficient consensus has been reached on the appointment details. If not, the user is directed to start over with a new proposal; of course, the user may choose at this point to ignore the lack of consensus and set the meeting anyway. Assuming consensus has been achieved, step 1723 an Appointment Set Message is constructed reflecting the now-agreed meeting details; the proposer's record of the appointment is updated as well. This message is sent to all correspondents using the Private Messaging Service at step 1724; it takes the usual path in steps 1725 through 1729.

Upon arrival of the Appointment Set Message at each correspondent's Agent 1510, Protocol module 1613 and User Interface modules 1611 and 1621 check whether appointments from this proposer may be set automatically in this correspondent's Personal Calendar module 1512. If not, at step 1730 the appointment is presented to the user with a request to approve or reject setting this appointment. Note that this is separate from the approval, already requested previously, to provide schedule information into the consensus coordination; in fact, this correspondent may have refused to provide such information, and the proposer may have chosen to set the appointment anyway. Once again, in step 1731 the user is asked for permission to act automatically in the future, this time on Appointment Set Messages from this proposer; this permission is independent of the permission to respond automatically to Availability Requests, as some users may be more sensitive at this step than the earlier one.

At step 1732, if the correspondent has approved the appointment as set, whether automatically or not, the appointment details are updated and the tentative status of the appointment is removed. Protocol module 1613 constructs an Appointment Accepted Message to inform the proposer that this correspondent has added this appointment to the schedule. On the other hand, if the user rejected the appointment as set, step 1733 constructs an Appointment Rejected Message to inform the proposer this correspondent will not be participating; the tentative appointment is removed from Personal Calendar module 1512 at this correspondent's Agent 1510.

Whether the appointment was accepted or rejected, at step 1734 the constructed response is handed off to the Private Messaging Service for conveyance to the proposer's Agent 1510. Once again, the message takes the usual path back in steps 1735 through 1738, and in step 1739 it is recognized and parsed by the proposer's Protocol module 1613. Finally, in step 1740 the appointment record in Personal Calendar 1512 at the proposer's Agent 1510 is updated to reflect the correspondent's acceptance or rejection of the appointment. Though not explicitly shown in the diagram, this will occur for each correspondent. Thus concludes the Appointment Coordination Process. Because it is built upon the Private Messaging System, the privacy and authenticity of messages is assured, allowing the coordination process itself to be quite simple.

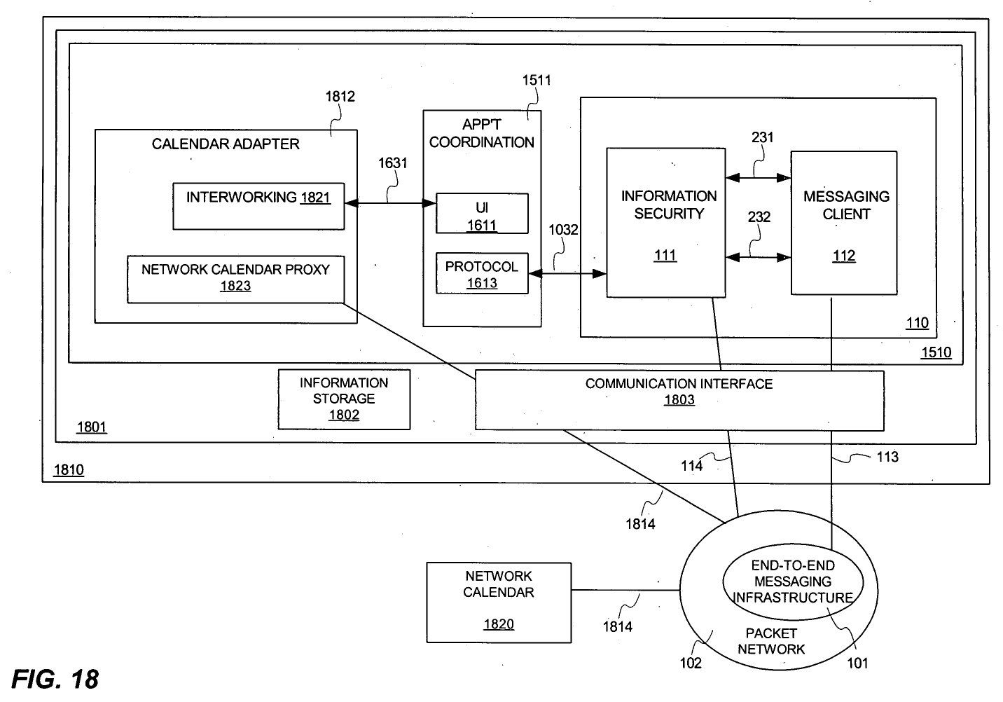

While the invention aspect of the foregoing descriptions is suitable for implementation in PCs, PDAs, and other devices which may be owned by or at least dedicated to a single user, a significant number of electronic calendar users keep their schedules in a centralized server accessible from shared computing devices. For example, in a manufacturing environment the factory workers generally do not have their own computers, but may have shared access to a kiosk computer whereby each person keeps an individualized schedule stored on a calendar server. It would be desirable to provide these users a way to participate in automatic appointment coordination. FIG. 18 depicts a mechanism for doing so. A Proxy Agent for Network Calendars is shown as an Agent 1510 in which Personal Calendar 1512 has been replaced by Calendar Adaptor 1812.

Proxy Agent Server 1810 comprises, as do the other servers described in this invention, a Programmable Computing Platform 1801 in which Agent 1510 runs as a software application. Platform 1801 provides the usual components, including Information Storage module 1802 for persistent configuration data, and Communication Interface 1803 for network connectivity. The Agent 1510 which runs in Proxy Agent Server 1810 has the same functionality as a PC-based or PDA-based Agent, including a complete Private Messaging Agent 110 and identical Appointment Coordination module 1511, except that Personal Calendar module 1512 is replaced by a Network Calendar Adaptor 1812. In place of a User Interface 1621 and Data Storage 1622, Adaptor 1812 provides only an Interworking module 1821, which interacts with Appointment Coordination module 1611 and its User Interface module 1611 to receive Availability Request and Appointment Set Messages from other users, and reply with appropriate Availability Response and Appointment Accepted/Rejected Messages.

When participating in an active coordination exchange as described above, Interworking module 1821 retrieves and modifies schedule information in Network Calendar 1820 via Network Calendar Proxy 1823. Proxy 1823 is designed to act as a user of Network Calendar 1820, using protocols that would allow a kiosk-computer user to manage his or her schedule. Its functionality is limited, however, to retrieving or updating the information about other users as required by Appointment Coordination module 1611 during the course of the procedure in FIG. 17. The protocol used between Proxy 1823 and Network Calendar 1820 may be a standard such as the Internet's Calendar Access Protocol (CAP), a proprietary protocol such as would be implemented in Microsoft's Exchange product, or any other mechanism. This interaction takes place via Interface 1814, which may be a path through Packet Network 102 as shown, or any other path including a private network or a direct link.

The next significant feature of Private Messaging System 100 is its ability to allow the sender of a Private or Restricted message to recall that message even after it has already arrived at its recipients. FIG. 20 depicts the process whereby this Message Recall function is effected. Essential to this process is the establishment of Restriction Storage module 215 as described in the context of FIG. 2, as well as the separate transport of ARM Records and their storage in Restriction Storage module 215.

The Message Recall process begins at step 2001, with the user who originally sent a Private or Restricted message selecting it via User Interface 221 and marking it for Recall via User Interface 211. In step 2002, Agent 110 locates the ARM Record for the message in Restriction Storage module 215, and updates that entry to reflect that the message has been Recalled. This update should include the date and time of the action. Note that the original Content Key should not be removed, because the sender should not lose access to the message's content when removing recipients' access.

To propagate this Recall action to recipients, the sending Agent 110 at step 2003 creates an Access Restrictions Message, addressed exactly as the original message was to all the original recipients. In an embodiment, simplicity of user experience dictates that the Recall action applies to every recipient equally. However, in an alternate embodiment it is possible to provide sufficient support in User Interface 211 that the Recall may apply to a subset of recipients independently. This new Access Restrictions Message correlating to an existing Private or Restricted message, is structured as previously described in step 1906, and signed and encrypted as previously described in step 1907. The ARM Record includes the date and time of the Recall. The Content Key is filled with a value indicative of the Recall, such as the string “Message Recalled.” The Access Restrictions Message is sent to Trusted Courier 120 by Agent 110's Background Mail Client 217 in step 2004.

Step 2005 depicts the replacement Access Restrictions Message being transported to Trusted Courier 120, carrying the new ARM Record, and arriving there in Background Mail Server 314. In step 2006 it is processed and relayed by Trusted Courier as described previously in the context of FIG. 19, and in step 2007 it proceeds to each of the recipients' Background Mail Clients 217.

Each recipient Agent 110 receives the new Access Restrictions Message in step 2008, processing it as previously described in the context of FIG. 19 with respect to decryption and signature validation. At step 2009, the ARM Record in Restriction Storage module 215 corresponding to the Message ID in the ARM Record just received is located. Note that if no matching ARM Record can be found, a new one is created. Agent 110 then at step 2010 updates the stored ARM Record with the new information just received in the new Access Restrictions Message. Specifically, the Content Key is replaced by the “Message Recalled” value, and the date and time of the Recall event are stored. This deletion of the original Content Key ensures that the content of the original Private or Restricted message can no longer be decrypted for presentation, thus effecting the Recall. Also, destruction of the message itself can be attempted if Interfaces 231 and 232 within Agent 110 provide sufficient functionality to do so.

Step 2011 shows the recipient Agent 110 constructing and sending back to the sending Agent 110 a Recall Receipt. This Receipt is identical in form and processing to the Delivery and Presentation Receipts previously described in the context of FIG. 19, except that the meaning of the Receipt relates to the Recall event currently under way. In a preferred embodiment, the Recall Receipt will also include information about whether and when the message has already been presented to the recipient user prior to the Recall. Steps 2012-2015 depict those same processing steps.

Thus concludes the basic Recall processing. If the original Private or Restricted message was not deleted from Message Storage module 222, either because Interfaces 231 and 232 were not capable of doing so, or because a copy of the original message had been exported from and later imported back into Messaging Client 112, it might at some later time be selected for presentation by one of its recipients. Step 2016 depicts this selection and presentation attempt. Agent 110, using the Message ID in the message as usual, locates the corresponding ARM Record in Restriction Storage module 215 at step 2017. Detecting in step 2018 that the message has no working Content Key, User Interface 211 at step 2019 informs the user that the message has been Recalled as of the stored date and time.

Since ARM Records are stored in Restriction Storage module 215 while Private and Restricted messages are stored with a user's ordinary messages in Message Storage module 222, it is possible for one of them to be lost or damaged independently of the other. The user, or an administrator acting on the user's behalf, is expected to practice good data hygiene according to principles well known not only to those skilled in the art but to ordinary users as well. Nevertheless, because one or the other may sustain damage it is necessary to consider the reaction of Private Messaging System 100 and its elements in such an event.

Message Storage module 222 is part of Messaging Client 112, and prior art mechanisms associated with the data hygiene practices mentioned above will generally already be available to recover from loss or damage in the information kept there. The special content format of Private and Restricted messages will have no adverse effect on those mechanisms, as the messages continue to have a standard structure surrounding the Private or Restricted content. Therefore, no additional procedures are required in the present invention to guard against loss or damage in Message Storage module 222. If a message is lost irretrievably, its ARM Record will simply never again be sought.

However, loss or damage in Restriction Storage module 215 is another matter altogether. This information is essentially invisible to users, who may not be aware of where the information is located or even that it exists at all. It is accessed behind the scenes whenever the user selects a Private or Restricted message for presentation. If the corresponding ARM Record is lost or damaged, presentation will fail and the user will not get the expected result. Therefore, it is very important to detect lost or damaged ARM Records and attempt to restore them.

The solution to this dilemma is found in the end-to-end nature of the ARM Record. Having been created by the Private or Restricted message's sender and shared with all recipients, the ARM Record is present in Restriction Storage module 215 at every Agent 110 which is a party to the message. If one of them no longer has the correct information, another probably still has it. FIG. 21 depicts the Access Restrictions Recovery process, whereby an Agent 110, which has sustained damage may restore the lost ARM Record from an Agent 110 that has not.

The process begins at step 2101 with a user selecting a Private or Restricted message for presentation, and Agent 110 attempting to perform the requested action. As previously described, in step 2102 Agent 110 will attempt to locate the corresponding ARM Record in Restriction Storage module 215 using the Message ID. Instep 2103, Agent 110 fails to find the ARM Record, or finds it and detects that it has been changed. Detecting damaged or tampered data items is well understood by those skilled in the art, and any of the usual error detection schemes will suit. In an embodiment, each individual ARM Record in Restriction Storage module 215 will be encrypted using some form of the users local password as established during Registration, and cryptographically signed with the same decryption/signing key that is used to sign messages.

Reacting to the lost or damaged ARM Record, Agent 110 will at step 2104 create a new one to replace the entry that is lost or damaged. The new ARM Record will have the Message ID of the original message, and be explicitly marked to note that a Recovery attempt is in progress, in an embodiment using a Content Key value of “Recovery Requested” and the date and time of the Recovery attempt. Also at this point, the user will be informed via User Interface 211 that the message cannot be presented due to an error, that recovery has been initiated, and that presentation should be tried again later. In an embodiment, User Interface 211 will also provide a mechanism for viewing the status of outstanding Recovery transactions so that the user can be aware of when to retry the presentation.

In step 2105, an ARM Recovery Request message is constructed. The Message ID from the original Private or Restricted message is used to identify the ARM Record being requested. In a preferred embodiment, the request may actually be formatted as a copy of the “Recovery Requested” ARM Record described above. The distribution headers from the original message are then consulted to determine to which address the ARM Recovery Request should be sent. If the current Agent 110 was a recipient of the original message, the ARM Recovery Request will be addressed to the sender, identified in the From: header. If the current Agent 110 was the sender of the original message, the ARM Recovery Request will be addressed to any one of the original recipients in the To:, CC:, or Bcc: headers. The ARM Recovery Request message is then signed and encrypted as usual, and sent to Trusted Courier 120 by Background Mail Client 217.

Steps 2106, 2107, and 2108 depict the ARM Recovery Request being transported to and handled by Trusted Courier 120 in the usual fashion as described above in the context of FIG. 19, and then transported to the chosen reference Agent 110 via its Background Mail Client 217. Note that for both of the Agents 110 involved, the messages are transported in the background because they have no meaning for the users involved, and because this process works regardless of the capabilities of Interfaces 231 and 232 at both Agents 110.

The chosen reference Agent 110 receives the ARM Recovery Request in step 2109, and performs the usual decryption and signature validation. Based on the Message ID in the request, the corresponding ARM Record is then sought in Restriction Storage module 217 at the reference Agent 110 in step 2110. If it is found, at step 2111 the ARM Record is used to construct a replacement Access Restrictions Message back to the requestor. The ARM Record may reflect any valid message status, including either an original Content Key, or one reflecting that the message has previously been Recalled or Expired. If it is not found, an empty ARM Record is used to construct the replacement Access Restrictions Message in step 2112; in an embodiment the Content Key is set to the string “Recovery Failed” to indicate so. No attempt is made to access the original message in Message Storage module 222, since in the general case the reference Agent 110 may be one with Interfaces 231 and 232 that are insufficient for such activity. In either case, the Access Restrictions Message is addressed only to the requestor and not to any other party to the original message, and it is signed and encrypted in the usual manner.

Steps 2113, 2114, and 2115 depict the new Access Restrictions Message carrying the replacement ARM Record being transported to and handled by Trusted Courier 120 in the usual fashion as described above in the context of FIG. 19, and then transported to the damaged Agent 110 via its Background Mail Client 217. As with the ARM Recovery Request and other Access Restrictions Messages, and for the same reasons, this one is carried in the background at every transport opportunity.

The requesting Agent 110 receives the new Access Restrictions Message at step 2116, performing the usual decryption and signature validation. The replacement ARM Record is merged into the “Recovery Requested” ARM Record at steps 2117 and 2118, as usual finding the correct entry by matching the Message ID. If the “Recovery Requested” ARM Record is lost or damaged upon arrival of the new Access Restrictions Message, it is simply restored directly from the newly received ARM Record.

Thus concludes the Access Restrictions Recovery process, and therewith the last of the distributed procedures relevant to Private Messaging System 100. Together, these procedures provide a robust service that accomplishes the goals of the present invention regarding simple user experience, user authentication, message privacy, content redistribution restrictions, and message recall.

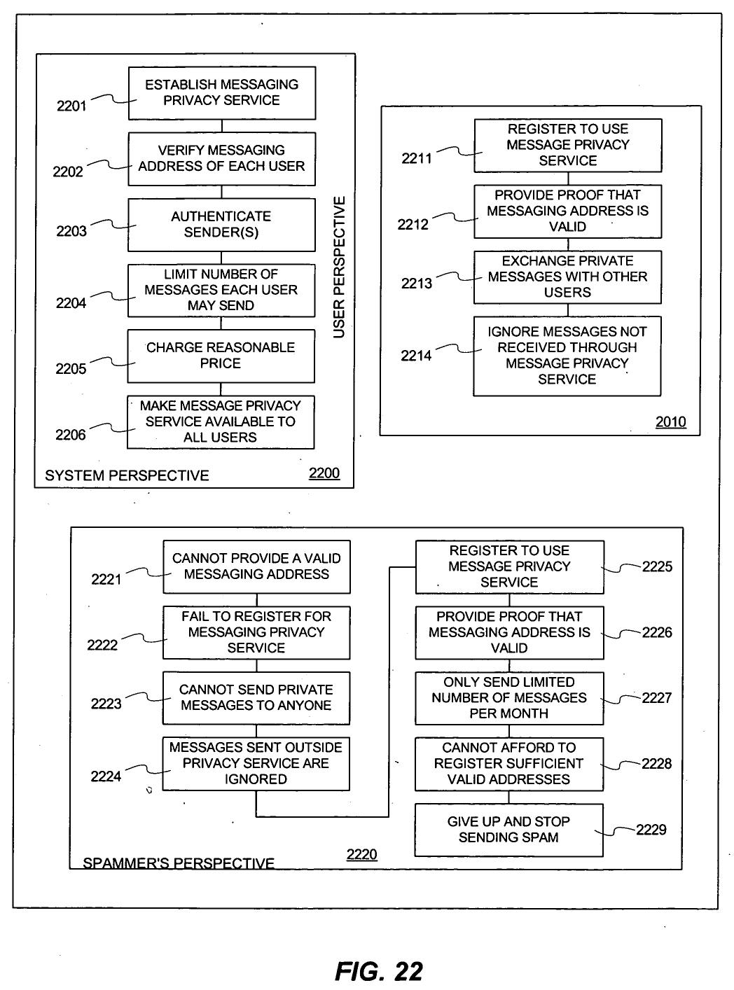

The final goal of the present invention, that of spam prevention, is accomplished not with additional distributed processing, but via careful operation of the procedures and elements of Private Messaging System 100. FIG. 22 depicts the method of spam prevention from three different perspectives: those of the system itself, a user of the system, and a spammer who might wish to use the system for delivering messages.

Beginning with System Perspective 2200, the first step is to establish a message privacy service using Private Messaging System 100 at step 2201, preferably by deploying an instance of Trusted Courier 120 and Inviting and Registering users. As has been discussed previously, essential to ensuring the authenticity of users is the practice, noted in step 2202, of verifying the messaging address for each prospective new user of the system using the Invitation and Registration processes described above. Then at step 2203, the system will authenticate the sender of every message against this verified registration, thereby preventing spoofing altogether.

To ensure that no one floods the system automatically with far more messages than real user can compose and send, at step 2204 the system is operated in such a manner as to limit the number of Private and Restricted messages each user may send in a particular period. This governor will tend to prevent the typical sender of bulk commercial messages from using the service because it will permit too few messages for an effective marketing campaign. In step 2205 a fair price is charged to each user, according to the value of the service for individuals who require Private or Restricted messages. Again, this price will generally be higher than a spammer can afford to pay for the limited number of messages. Finally, in step 2206 the system is operated in such a manner as to attract as many users as possible, with the ultimate goal of serving every legitimate user in the network at large. Every user served in the Private Messaging System 100 is a user to whom spam is not delivered, so the more users the system has, the smaller will be spammers' audience.

From the User's Perspective 2210, spam prevention begins at step 2211 with the decision and action to register for the services of Private Messaging System 100. In step 2212, the user will provide an authentic messaging address that is proven using the Registration process. This assures this user and all others that every user in the system is real. Step 2213 depicts the user exchanging Private and Restricted messages with other users, building not only confidence in the system and its services but also a set of correspondents who also use the system. When a critical mass of correspondents are present in the system, at step 2214 the user may choose to ignore all messages that do not arrive via the Private Messaging System 100. A this point, the user becomes invulnerable to spam.

Finally, from a Spammer's Perspective 2220 there are two possible approaches to Private Messaging System 100. First, the spammer may wish to join the system as a user but continue exercising current common practices such as header forgery. Step 2221 prevents this by requiring each user to have a messaging address that can be verified by the Invitation and Registration processes. Such a spammer will fail to register at step 2222. As stated in step 2223, the spoofing spammer will therefore be unable to send Private or Restricted messages to anyone. Since, as stated in step 2224 all legitimate users will by now be ignoring every message that does not arrive via this system, the spammer's potential audience is significantly reduced.

The second approach a spammer may take is to Register for service at step 2225, providing a verifiable messaging address at step 2226. This eliminates the possibility of hiding behind a fake address, but as stated at step 2227 only a limited number of messages may be sent in any service period. Since the message limits are set based on normal individual users' needs, the spammer will find the audience severely limited. The number of messages required to get a profitable response simply cannot be sent by a single user. At step 2228, the spammer will consider establishing multiple accounts, each of which will send as many messages as are permitted. However, because the service is priced to provide value to individual users, the spammer will be unable to afford establishing sufficient accounts to get to the number of messages required to get a profitable response.

In either case, therefore, at step 2229 the spammer will conclude that the business case for sending unsolicited messages in bulk cannot be executed profitably, and will give up on spamming as a way to make a living. Thus Message Privacy System 100 will lead to the eventual elimination of spam altogether.

The invention has been described above with reference to the figures and examples. It is not intended that the invention be limited to the specific examples and embodiments shown and described, but that the invention be limited in scope only by the claims appended hereto. It will be evident to those skilled in the art that various substitutions, modifications, and extensions may be made to the embodiments as well as to various technologies which are utilized in the embodiments. It will also be appreciated by those skilled in the art that such substitutions, modifications, and extensions fall within the spirit and scope of the invention, and it is intended that the invention as set forth in the claims appended hereto includes all such substitutions, modifications, and extensions.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

We claim:

1. An electronic message system comprising:
a messaging infrastructure to transport an electronic message, wherein the message includes a message header;
a first messaging agent and a second messaging agent in communication with the messaging infrastructure; and
a message server to route the message from the first messaging agent to the second messaging agent, wherein the network server is in communication with the messaging infrastructure, and wherein the message header is encrypted when being transported by the messaging infrastructure.

2. The electronic message system of claim 1, wherein the message server determines whether the first and second messaging agents are registered with the message server.

3. The electronic message system of claim 2, wherein the message is rejected by the message server if the first messaging agent is not registered with the message server.

4. The electronic message system of claim 2, wherein the messaging server determines the second messaging agent is not registered and sends an invitation to register to an address in the message header associated with the second messaging agent.

5. The electronic message system of claim 2, wherein the message is held at the message server until the second messaging agent is registered with the message server.

6. The electronic message system of claim 4, wherein the invitation to register includes a referral code to verify the address.

7. The electronic message system of claim 1, wherein the first messaging agent cannot send more than a predetermined number of messages in a predetermined period of time.

8. The electronic message system of claim 1, wherein the first messaging agent is charged a fee for sending the message.

9. The electronic message system of claim 1, wherein the first messaging agent restricts the decryption of the message by the second messaging agent.

10. The electronic message system of claim 9, wherein the first messaging agent sends an access restrictions message to the second messaging agent, wherein the access restrictions message comprises a predefined restriction on when the second messaging agent can decrypt the message.

11. The electronic message system of claim 10, wherein the access restrictions message is part of the message originally sent by the first messaging agent.

12. The electronic message system of claim 1, wherein the first messaging agent disables the decryption of the message by the second messaging agent.

13. The electronic message system of claim 12, wherein the first messaging agent disables the decryption by deleting a decryption key used by the second messaging agent to decrypt the message.

14. The electronic message system of claim 1, wherein the message comprises message content and the message content is separately encrypted from the message header.

15. The electronic message system of claim 14, wherein the message content is encrypted using a content key and the message header is encrypted using a message server key.

16. The electronic message system of claim 1, wherein the message is an email message.

17. The electronic message system of claim 1, wherein the first and second messaging agents are implemented on, independently, a personal computer, a cellular telephone, or a personal digital assistant.

18. The electronic message system of claim 1, wherein access to the first and second messaging agents requires a password.

19. A method of transporting an electronic message, comprising:
sending the message from a sender to a message server, wherein the message server verifies the sender is a sending agent that is registered with the message server;
decrypting a message header in the message to ascertain one or more recipients to receive the message;
verifying the one or more recipients are recipient agents that are registered with the message server; and
sending the message from the message server to the one or more recipient agents that are registered with the message server.

20. The method of claim 19, comprising:
encrypting the message header at the message server before the message is sent to the one or more recipient agents.

21. The method of claim 19, wherein the message is rejected by the message server if the sender is not a registered sending agent.

22. The method of claim 19, comprising:
holding a copy of the message at the message server for the one or more recipients that are unregistered recipient agents.

23. The method of claim 22, comprising:
sending the copy of the message to the unregistered recipient agents after they have registered with the message server.

24. The method of claim 19, comprising:
sending an invitation to register to the one or more recipients not registered with the message server.

25. The method of claim 24, wherein the invitation to register comprises an unencrypted message providing instructions for how to install an agent and establish an account with the message server.

26. The method of claim 24, comprising:
registering the one or more of recipients not registered to make them recipient agents registered with the message server.

27. The method of claim 26, wherein the registering of the one or more recipients comprises:
providing requested information about the recipient to the message server;
installing the recipient agent at the recipient; and
exchanging cryptographic keys between the message server and the recipient agent installed at the recipient.

28. The method of claim 27, wherein the cryptographic keys include a message server key used to encrypt and decrypt the message header.

29. The method of claim 19, comprising:
determining that one or more of the registered recipient agents refuse messages that include undesirable content;
examining the message for the undesirable content, wherein the message is not sent to the recipient agent if it contains the undesirable content; and
sending a delivery refusal message to the sender indicating that the undesirable content caused the message to be refused by the recipient agent.

30. A method of transporting an electronic message comprising:
sending a first server encrypted message from a sending agent to a message server, wherein the first server encrypted message comprises a message header and encrypted message content that has been encrypted using a content key, and wherein the first server encrypted message is encrypted using an sender message server key;
ascertaining a recipient agent from the message header that has been decrypted using the sender message server key, wherein the encrypted message content is not decrypted at the message server; and
sending a second server encrypted message to the recipient agent where the second server encrypted message is decrypted using a recipient message server key and the encrypted message content is decrypted using the content key.

31. The method of claim 30, wherein the electronic message is encrypted with symmetric or asymmetric encryption techniques.

32. The method of claim 30, wherein the message server lacks the content key used to decrypt the encrypted message content.

33. The method of claim 32, wherein the message content key is sent from the sending agent to the recipient agent on a different path than the electronic message.

34. A method of controlling access to an electronic message comprising:
sending an access restriction message from a sending agent, wherein the access restriction message includes instructions to delete a content key used by a receiving agent to decrypt at least a portion of the electronic message; and
deleting the content key, wherein the receiving agent can no longer decrypt said at least portion of the electronic message.

35. The method of claim 34, wherein the electronic message is first sent from the sending agent to a message server, and then sent from the message server to the receiving agent.

36. The method of claim 34, wherein the access restrictions message is sent from the sending agent to the recipient agent on a different path than the electronic message.

37. The method of claim 34, wherein the content key is stored on a computer upon which the receiving agent also operates.

38. The method of claim 34, wherein the electronic message is stored on a computer upon which the receiving agent also operates.

39. The method of claim 34, wherein the electronic message comprises a message header and a message content, and wherein the content key is used to decrypt the message content.

40. The method of claim 39, wherein the sending agent encrypts the message content with the content key to form an encrypted message content.

41. The method of claim 40, wherein the sending agent encrypts the message header and the encrypted message content with a message server key.

42. A method of restricting transport of an electronic message comprising:
sending the electronic message from a sending agent to a message server, wherein the electronic message is addressed to one or more recipient agents;
confirming by the message server that the sending agent and the one or more recipient agents are registered with the message server, wherein the electronic message is not sent to any of the one or more recipient agents if the sending agent is not registered; and
sending the electronic message from the message server to the one or more recipient agents that are registered with the message server.

43. The method of claim 42, wherein at least a portion of the electronic message is encrypted.

44. The method of claim 43, wherein the electronic message comprises a message header and a message content, and the message content is encrypted with a content key to form encrypted message content.

45. The method of claim 44, wherein the message header and encrypted message content is encrypted using a message server key.

46. The method of claim 42, wherein an invitation to register is sent by the message server to the recipient agents that are not registered.

47. The method of claim 46, wherein the invitation to register comprises an unencrypted message providing instructions for how to install an agent and establish an account with the message server.

48. The method of claim 42, wherein the sending agent cannot send more than a preset number of copies of the electronic message in a preset period of time.

49. The method of claim 42, wherein the sending agent is charged a fee for each copy of the electronic message that is sent.

50. A method of registering a recipient for an electronic message system, comprising:
sending an invitation to register from a message server to the recipient;
providing requested information about the recipient to the message server;
installing an agent at the recipient; and
exchanging cryptographic keys between the recipient agent and the message server.
